(19) United States
(12) Patent Application Publication
(10) Pub. No.: US 2017/0207464 A1
(43) Pub. Date: Jul. 20, 2017

(54) OXYGEN ELECTRODE AND A METHOD OF MANUFACTURING THE SAME

(71) Applicants: Elod Lajos Gyenge, Vancouver (CA); Pooya Hosseini Benhangi, Vancouver (CA)

(72) Inventors: Elod Lajos Gyenge, Vancouver (CA); Pooya Hosseini Benhangi, Vancouver (CA)

(21) Appl. No.: 15/251,267

(22) Filed: Aug. 30, 2016

Related U.S. Application Data
(60) Provisional application No. 62/279,334, filed on Jan. 15, 2016.

(51) Int. Cl. H01M 4/88; H01M 4/86; H01M 4/90; C25D 13/20; H01M 8/18; C25D 13/02; C25D 13/10; C25D 13/12; H01M 12/08; H01M 8/20

(52) U.S. Cl. CPC H01M 4/8853; H01M 12/08; H01M 4/8615; H01M 4/9016; H01M 8/20; H01M 8/188; C25D 13/02; C25D 13/10; C25D 13/12; C25D 13/20; H01M 2004/8689

(57) ABSTRACT

Various embodiments provide a method of manufacturing an oxygen electrode. The method comprises: providing an electrically conductive substrate; depositing an electrocatalyst layer on the substrate; and intercalating alkali-metal ions into the catalyst layer. Some other embodiments provide an oxygen electrode manufactured in accordance with the method and a metal-air battery, a regenerative H₂—O₂ fuel cell, a direct fuel cell, and an electrochemical cell comprising the oxygen electrode.

### TECHNICAL FIELD

The present disclosure is directed to a method of manufacturing an oxygen electrode and an oxygen electrode. Specific embodiments relate to a rechargeable metal-air battery, a regenerative H₂—O₂ fuel cell, a direct fuel cell, and an electrochemical cell, including the oxygen electrode.

### BACKGROUND

Oxygen or air electrodes can be used in power sources, such as, for example, batteries and fuel cells. In operation, during power generation, the oxygen electrode permits oxygen from air surrounding the electrode to be used in electrochemical reactions within the power source. In a charge mode of the power source, external power is consumed and the electrochemical reactions are reversed on the oxygen electrode such that oxygen gas is evolved. The same reaction occurs when the electrode is used as an anode in an electrochemical cell, such as, during electrosynthesis of diverse chemicals or water electrolysis.

There is a continuing desire to improve oxygen electrodes, and to improve the manner in which oxygen electrodes are manufactured, so as to improve the energy efficiency of power sources and electrochemical synthesis reactors.

### SUMMARY

A first aspect provides a method of manufacturing a bifunctional oxygen electrode to catalyze both the oxygen reduction and oxygen evolution reactions on the same surface. The method includes providing an electrically conductive substrate; depositing an electrocatalyst layer on the substrate; and intercalating alkali-metal ions into the electrocatalyst layer, wherein the intercalation is electric potential driven and the alkali-metal ions are provided by an alkali-metal salt dissolved in an aqueous solution.

In an embodiment, the electrocatalyst layer comprises at least one of the following: manganese oxide, a perovskite, and an oxide having a fluorite-related structure. The perovskite can be lanthanum cobalt oxide with the formula LaCoOₓ, where x is between 0.1 to 5. In one particular embodiment, the perovskite is LaCoO₃. Alternatively, the perovskite can be lanthanum nickel oxide with the formula LaNiOₓ. where x is between 0.1 to 5. The oxide having the fluorite-related structure can be neodymium iridium oxide with the formula NdₓIrO_{y}, where x is between 0.1 to 5 and y is between 0.1 to 10. In one particular embodiment, the oxide having a fluorite-related structure is Nd₃IrO₇.

In an embodiment, depositing an electrocatalyst layer on the substrate includes depositing the electrocatalyst layer on the substrate in the presence of a surfactant using an anodic electrodeposition process. In an embodiment, the surfactant is one of the following: sodium dodecyl sulfate, hexadecyl-trimethyl-ammonium bromide, and Triton X-100. In an embodiment, the anodic electrodeposition process is performed at a temperature of between 295K and 343K. In an embodiment, the anodic electrodeposition process is performed at an anodic potential of between 800 mV and 2000 mV vs. a mercury/mercury oxide (Hg/HgO) reference electrode (MOE). In an embodiment, the anodic electrodeposition process is performed using a liquid bath having a surfactant concentration of between 0% vol and 30% vol. In an embodiment, the anodic electrodeposition process is performed using a liquid bath having a manganese (II) ion concentration of between 0.1M and 3M. In yet another embodiment, the anodic deposition process is performed using a liquid bath having a cobalt (II) or nickel (II) ion concentration of between 0.001M and 3M.

The concentration of lanthanum (III) ions during the anodic electrodeposition process can be between 0.001 M and 3M. Lanthanum diffusion into the catalyst layer can be performed electrophoretically at a constant cathodic current density between −1 to −100 mA cm⁻².

In an embodiment, the step of depositing an electrocatalyst layer on the substrate comprising spraying an electrocatalyst ink on the substrate. The electrocatalyst ink comprises at least one component selected from a group consisting of: manganese oxide particles, lanthanum cobalt oxide particles, lanthanum nickel oxide particles, neodymium iridium oxide particles, carbon particles, graphene flakes, nitrogen-doped graphene flakes, graphite fibers, graphite particles, multi walled carbon nanotubes, single walled carbon nanotubes, acetylene black, Nafion® resin solution or powder, polytetrafluoroethylene (PTFE) powder or suspension, and water and isopropyl alcohol.

In an embodiment, prior to depositing an electrocatalyst layer on the substrate, the substrate is pretreated using an acidic acid selected from a group consisting of: nitric acid, acetic acid, phosphoric acid, sulfuric acid and combinations thereof.

In an embodiment, prior to intercalating alkali-metal ions into the catalyst layer, the substrate having the electrocatalyst layer deposited thereon is post-treated by washing in isopropyl alcohol.

In an embodiment, intercalating alkali-metal ions into the catalyst layer includes performing potential driven intercalation in which the alkali-metal ions are provided by an alkali-metal salt dissolved in an aqueous solution. In an embodiment, the potential driven intercalation of the alkali-metal ions is performed at a constant cathodic current density of −1 to −100 mA cm⁻².

In an embodiment, intercalating alkali-metal ions into the catalyst layer includes performing open circuit voltage intercalation in which the alkali-metal ions are provided by a solution in contact with the substrate having the electrocatalyst layer deposited thereon.

In an embodiment, the alkali-metal is any one of the following: potassium, lithium, sodium, or cesium. In another embodiment, the alkali-metal is a combination of any of the following: potassium, lithium, sodium and cesium.

In an embodiment, the electrically conductive substrate comprises any one of the following: carbon cloth, carbon fiber paper, graphite felt, metal mesh such as nickel or titanium mesh, metal foam such as nickel or titanium foam, graphene, reticulated vitreous carbon or carbon nanotubes. In an embodiment, the substrate is porous.

A second aspect provides an oxygen electrode manufactured in accordance with the method of the first aspect.

A third aspect provides a metal-air battery comprising the oxygen electrode of the second aspect.

A fourth aspect provides a regenerative H₂—O₂ fuel cell comprising the oxygen electrode of the second aspect.

A fifth aspect provides a direct fuel cell comprising the oxygen electrode of the second aspect.

A sixth aspect provides an electrochemical cell, such as a water electrolyzer, comprising the oxygen electrode of the second aspect.

A seventh aspect comprises a redox flow battery comprising the oxygen electrode of the second aspect.

### BRIEF DESCRIPTION OF THE DRAWINGS

In the drawings, like reference characters generally refer to like parts throughout the different views. The drawings are not necessarily to scale, emphasis instead generally being placed upon illustrating the principles of some embodiments. In the following description, various embodiments are described with reference to the following drawings.

FIG. 1 is a schematic view of a metal-air battery having an oxygen electrode, in accordance with an embodiment.

FIG. 2 is a flow diagram illustrating a method of manufacturing an oxygen electrode in accordance with an embodiment.

FIG. 3 is a table of BET surface area of single and mixed oxide catalyst layers.

FIGS. 4A and 4B are graphs showing IR-corrected cyclic voltammograms of GDEs with MnO₂, LaCoO₃, Nd₃IrO₇, MnO₂—LaCoO₃ and MnO₂—Nd₃IrO₇ catalysts. FIG. 4A shows MnO₂, LaCoO₃ and Nd₃IrO₇, whereas FIG. 4B shows MnO₂—LaCoO₃ and MnO₂—Nd₃IrO₇. Electrolyte used was: N₂-saturated 6 M KOH at 293 K. The oxide loadings were 0.5 mg cm⁻² each. Rotating electrode speed and potential scan rate were 400 rpm and 5 mV s⁻¹, respectively. Cycle number three is reported in all cases.

FIGS. 5A and 5B are graphs showing initial stage IR-corrected bifunctional ORR/OER Tafel-lines of GDEs with MnO₂, LaCoO₃, Nd₃IrO₇, MnO₂—LaCoO₃ and MnO₂—Nd₃IrO₇ catalysts. FIG. 5A shows ORR, whereas FIG. 5B shows OER. Electrolyte used: O₂ saturated 6 M KOH at 293 K. Electrode potential scanning between 233 to 1683 mV_{RHE}. The oxide loadings were 0.5 mg cm⁻² each. Rotating electrode speed and potential scan rate were 400 rpm and 5 mV s⁻¹, respectively. Cycle number three is reported in all cases. The numbers associated with each line represent the respective apparent Tafel slopes.

FIG. 6 is a table of the apparent exchange current densities and Tafel slopes for the initial stage ORR and OER activities of the investigated GDEs with fresh catalysts. 293 K. 6 M KOH. The exchange current densities are expressed per geometric area. The standard error of the mean calculated based on six replicates is indicated.

FIGS. 7A and 7B are graphs showing bifunctional activation effect evaluation by long-term (e.g. six days) exposure of MnO₂—LaCoO₃ to alkali-metal hydroxide solutions: LiOH, NaOH, KOH, CsOH. Initial stage IR-corrected polarization curves obtained by potential scanning between 633 to 1483 mV_{RHE} in O₂ saturated 6 M KOH at 293 K. Other conditions idem to FIGS. 5A and 5B.

FIGS. 8A, 8B, 8C and 8D are graphs showing XPS spectra of MnO₂—LaCoO₃ and MnO₂—Nd₃IrO₇ before and long-term exposure to 6 M KOH: FIG. 8A) MnO₂—LaCoO₃ fresh electrode, FIG. 8B) MnO₂—LaCoO₃ electrode after being exposed to 6 M KOH for 6 days at 313 K and 400 rpm at open-circuit, FIG. 8C) MnO₂—Nd₃IrO₇ fresh electrode, FIG. 8D) MnO₂—Nd₃IrO₇ electrode after being exposed to 6 M KOH for 6 days at 313 K and 400 rpm at open-circuit.

FIGS. 9A and 9B are graphs showing EDX spectra of the activated catalyst layers after 6 days exposure to 6 M KOH: FIG. 9A) MnO₂—LaCoO₃, FIG. 9B) MnO₂—Nd₃IrO₇. Conditions idem to FIGS. 8A, 8B, 8C and 8D.

FIGS. 10A, 10B and 10C are graphs showing EELS analysis of MnO₂—LaCoO₃ under three different conditions: I) Initial stage, II) After being activated in KOH for 6 days (idem to FIGS. 8A, 8B, 8C and 8D) and cycled between the ORR and OER regions for ten cycles, III) After being activated in KOH for 6 days and cycled between the ORR and OER regions for one hundred cycles. FIG. 10A) EELS spectrum showing Mn (L_{2,3}) edges, FIG. 10B) EELS spectrum showing O (K) edges, FIG. 10C) L₃:L₂ Branching ratio versus valence state for Mn oxides. The (▪) and (▴) symbols represent reference data points obtained from M. Minakshi, Journal of Electroanalytical Chemistry, 616, 99 (2008) and the ones calculated directly from EELS spectrum for each sample, respectively. The errors associated with Mn valance state, L₃:L₂ branching ratio and energy loss are ±0.2, ±0.001 and ±0.1 eV, respectively.

FIGS. 11A and 11B are graphs showing XPS spectra of the potential driven K⁺ insertion (PDI) activated catalyst layers: FIG. 11A) MnO₂—LaCoO₃ electrode after seven rounds of PDI activation, FIG. 11B) MnO₂—Nd₃IrO₇ electrode after six rounds of PDI activation.

FIGS. 12A and 12B are graphs showing the effect of potential driven K⁺ insertion on the initial stage bifunctional polarization of MnO₂—LaCoO₃. FIG. 12A) ORR, FIG. 12B) OER. Other conditions idem to FIGS. 5A and 5B.

FIGS. 13A and 13B are graphs showing the effect of potential driven K⁺ insertion on the initial stage bifunctional polarization of MnO₂—Nd₃IrO₇. FIG. 13A) ORR, FIG. 13B) OER. Other conditions idem to FIGS. 5A and 5B.

FIGS. 14A and 14B are graphs showing the effect of potential driven K⁺ insertion on the initial stage bifunctional polarization of individual oxides: MnO₂, LaCoO₃ and Nd₃IrO₇. FIG. 14A) ORR, FIG. 14B) OER. Other conditions idem to FIGS. 5A and 5B.

FIGS. 15A and 15B are graphs showing galvanostatic polarization of mixed oxide catalysts without and with potential driven K⁺ insertion activation: FIG. 15A) MnO₂—LaCoO₃ and FIG. 15B) MnO₂—Nd₃IrO₇. Tests started with 5 mA cm⁻² anodically applied to each GDE for 2 hrs followed by −2 mA cm⁻² applied cathodically for 30 min in O₂ saturated 6 M KOH. The rotation speed and temperature was 400 rpm and 293 K, respectively. The oxide loadings were 0.5 mg cm⁻² each.

FIG. 16 is a graph showing a comparison between the ORR and OER overpotential values of the catalyst materials investigated (shown as (▴)) with those reported in known literature for other bifunctional electrodes (shown as (♦)). For the catalyst investigated in this study: a) Fresh catalyst without activation. b) Activation by K⁺ insertion at open-circuit potential (OCP), c) Activation by K⁺ insertion using six rounds of potential driven intercalation (PDI), d) Activation by K⁺ insertion using three rounds of PDI. The error associated with overpotential values is ±5 mV.

FIG. 17 is a table of experimental design factors and their levels for 24−1+3 factorial design runs.

FIGS. 18A and 18B are graphs showing IR-corrected linear sweep voltammograms of nitric acid treated 40% wt PTFE treated carbon cloth starting from 0 to 2500 mV_{MOE} in presence of: FIG. 18A) 5% vol and FIG. 18B) 10% vol of Triton X-100, SDS and CTAB in a solution of 0.2 M Mn(CH₃COO)₂ and 0.1 M Na₂SO₄ at 293 K. The scan rate and rotation speed were 5 mV s⁻¹ and 400 rpm, respectively.

FIG. 19 shows graphs of XPS spectra of three representative electrodeposited MnOx samples at Mn 2p, Mn 3s and O 1s regions. The electrodeposition factors for each sample are as follow: T1 (C: 0.3 M, T: 295 K, S: Triton, 10% vol, E: 800 mV_{MOE}), T9 (C: 0.1 M, T: 343 K, S: Triton, 10% vol, E: 800 mV_{MOE}), T10 (C: 0.3 M, T: 295 K, S: Triton, 0% vol, E: 1600 mV_{MOE}).

FIG. 20 is a table of XPS peak analysis of electrodeposited MnOx samples shown in FIG. 19. The deconvoluted data for Mn 2p, Mn 3s and O 1s are shown. The electrodeposition conditions for each sample can be found in FIG. 19. The error associated with binding energy of peak position is ±0.05 eV.

FIG. 21 is a graphs of FTIR spectra of MnOx samples electrodeposited on the carbon cloth as substrate in presence of SDS, Triton X-100 and CTAB. The electrodeposition factors for each sample are as follow: Carbon cloth (no electrodeposited material), SDS (C: 0.3 M, T: 295 K, S: 10% vol, E: 800 mV_{MOE}), Triton (C: 0.1 M, T: 343 K, S: 10% vol, E: 800 mV_{MOE}), CTAB (C: 0.3 M, T: 343 K, S: 10% vol, E: 1600 mV_{MOE}).

FIG. 22 is a table of design matrix (in random order), Mn valance, calculated loadings and responses for the factorial design experiments in presence of Triton X-100. ^{a} The Mn valance calculated based on the XPS results. The bold value corresponds to higher content of that specific Mn valance in the electrodeposited manganese oxide. * Average factorial response with standard error of mean value calculated based on the center point (0000) tests (The percentage of relative error is specified in parenthesis): ^{b} 20.6±0.7 (3%) mg cm⁻², ^{c} −322±48 (15%) mA g⁻¹, ^{d} 4742±495 (10%) mA g⁻¹, ^{e} 625±21 (3%) mV.

FIGS. 23A, 23B and 23C are surface plots for 24−1+3 factorial design in presence of Triton X-100 including responses as well as most important factors and two-factor interactions: FIG. 23A) ORR mass activity at −300 mV_{MOE}, FIG. 23B) OER mass activity at 600 mV_{MOE} and FIG. 23C) ORR/OER potential window at −2 and 2 mA cm⁻², respectively. Details of each run has been given in FIG. 22. Red and green colors in the surface plots correspond to highest and lowest values of each response, respectively.

FIG. 24 is a table of design matrix (in random order), Mn valance, calculated loadings and responses for the factorial design experiments in presence of SDS. ^{a} The Mn valance calculated based on the XPS results. The bold value corresponds to higher content of that specific Mn valance in the electrodeposited manganese oxide. * Average factorial response with standard error of mean value calculated based on the center point (0000) tests (The percentage of relative error is specified in parenthesis): ^{b} 13.9±1.9 (14%) mg cm⁻², ^{c} −395±18 (5%) mA g⁻¹, ^{d} 4742±953 (8%) mA g⁻¹, ^{e} 684±8 (1%) mV

FIGS. 25A, 25B and 25C are surface plots for 24−1+3 factorial design in presence of SDS including responses as well as most important factors and two-factor interactions: FIG. 25A) ORR mass activity at −300 mV_{MOE}, FIG. 25B) OER mass activity at 600 mV_{MOE} and FIG. 25C) ORR/OER potential window at −2 and 2 mA cm⁻², respectively. Details of each run has been given in FIG. 24. Red and green colors in the surface plots correspond to highest and lowest values of each response, respectively.

FIG. 26 is a table of design matrix (in random order), Mn valance, calculated loadings and responses for the factorial design experiments in presence of CTAB. ^{a} The Mn valance calculated based on the XPS results. The bold value corresponds to higher content of that specific Mn valance in the electrodeposited manganese oxide. * Average factorial response with standard error of mean value calculated based on the center point (0000) tests (The percentage of relative error is specified in parenthesis): ^{b} 8.3±0.7 (6%) mg cm⁻², ^{c} −231±10 (4%) mA g⁻¹, ^{d} 4847±219 (5%) mA g⁻¹, ^{e} 857±40 (5%) mV.

FIGS. 27A, 27B and 27C are surface plots for 24−1+3 factorial design in presence of CTAB including responses as well as most important factors and two-factor interactions: FIG. 27A) ORR mass activity at −300 mV_{MOE}, FIG. 27B) OER mass activity at 600 mV_{MOE} and FIG. 27C) ORR/OER potential window at −2 and 2 mA cm⁻², respectively. Details of each run has been given in FIG. 26. Red and green colors in the surface plots correspond to highest and lowest values of each response, respectively.

FIGS. 28A and 28B are graphs showing IR-corrected bifunctional performance comparison of electrodeposited MnOx in presence of different surfactants, i.e. Triton X-100, SDS and CTAB: FIG. 28A) ORR, FIG. 28B) OER. The electrodeposition factors for each sample are as follow: Carbon cloth substrate (no electrodeposited material), CTAB-Run no. 6 (C: 0.1 M, T: 343 K, S: 10% vol, E: 800 mV_{MOE}), SDS-Run no. 1 (C: 0.3 M, T: 295 K, S: 10% vol, E: 800 mV_{MOE}), Triton-Run no. 9 (C: 0.1 M, T: 343 K, S: 10% vol, E: 800 mV_{MOE}). Electrolyte: O2 saturated 6 M KOH at 293 K. Rotating electrode speed and potential scan rate were 400 rpm and 5 mV s⁻¹, respectively. Cycle number five is reported in all cases.

FIGS. 29A to 28F are SEM micrographs of best performing electrodeposited MnOₓ oxides on nitric acid pre-treated carbon cloth: FIGS. 29A and 29B) Triton run no. 9, FIGS. 29C and 29D) SDS run no. 1, FIGS. 29E and 29F) CTAB run no. 6. The electrodeposition factors are stated in FIG. 28.

FIG. 30 is a graph showing galvanostatic polarization comparison of best performing electrodeposited manganese oxide in presence of Triton X-100 and commercial manganese oxide GDES: I) Mixed manganese oxide/C GDE from Gaskatel GmbH (loading unknown), II) γ-MnO2/C from Sigma Aldrich (loading 5.6 mg cm⁻²) and III) Triton run no. 9 (C: 0.1 M, T: 343 K, S: 10% vol, E: 800 mV_{MOE}) (calculated loading 17.5 mg cm⁻²). Tests started with 5 mA cm⁻² anodically applied to each GDE for 2 hrs followed by −2 mA cm⁻² applied cathodically for 30 min in O₂ saturated 6 M KOH. The rotation speed and temperature was 400 rpm and 293 K, respectively.

### DETAILED DESCRIPTION

Any terms not directly defined herein shall be understood to have the meanings commonly associated with them as understood within the art. Certain terms are discussed below, or elsewhere in the specification, to provide additional guidance to the practitioner in describing the devices, methods and the like of embodiments, and how to make or use them. It will be appreciated that the same thing may be said in more than one way. Consequently, alternative language and synonyms may be used for any one or more of the terms discussed herein. No significance is to be placed upon whether or not a term is elaborated or discussed herein. Some synonyms or substitutable methods, materials and the like are provided. Recital of one or a few synonyms or equivalents does not exclude use of other synonyms or equivalents, unless it is explicitly stated. Use of examples in the specification, including examples of terms, is for illustrative purposes only and does not limit the scope and meaning of the embodiments of the invention herein.

Directional terms such as “top”, “bottom”, “side”, “end”, “upwards”, “downwards”, “horizontally”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first element is coupled to a second element, that coupling may be through a direct connection or through an indirect connection via other elements and connections.

### Overview

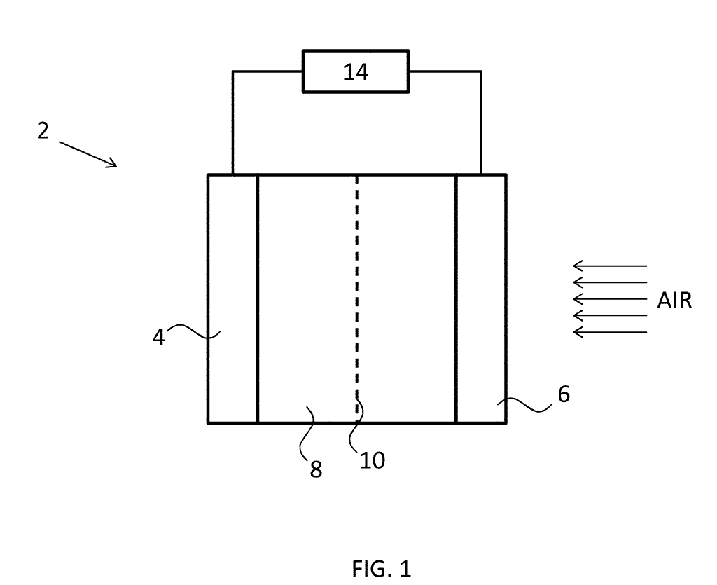

FIG. 1 illustrates a metal-air battery 2 in accordance with an embodiment. In the present embodiment, the metal-air battery 2 is a zinc-air battery; however, it is to be understood that in some other embodiments, a different type of metal-air battery may be used. For example, the metal may be a magnesium, lithium, or aluminum.

In an embodiment, the battery 2 includes a zinc electrode 4 and an oxygen (or air) electrode 6. The zinc electrode 4 is separated from the oxygen electrode 6 by an electrolyte 8. The electrolyte 8 may include a hydroxide, such as, for example, potassium hydroxide. The zinc electrode 4 contacts the electrolyte 8 and includes zinc such that it can release zinc ions into the electrolyte 8. The oxygen electrode 6 also contacts the electrolyte 8 and is formed of an electrically conductive substrate, such as, for example, a carbon cloth, a metal mesh, or the like. The oxygen electrode 6 is exposed to air (as indicated in FIG. 1 by arrows) and permits the passage of oxygen (O₂) molecules from the air through its structure. For example, the oxygen electrode 6 may be porous or may include one or more passages through its structure. A portion of the oxygen electrode 6 facing the electrolyte 8 includes an electrocatalyst layer 10. In an embodiment, the electrocatalyst layer may cover a majority or all of an outer surface of the oxygen electrode 6; however, in another embodiment, the electrocatalyst layer may cover only a minority or one side of the oxygen electrode 6. For example, the electrocatalyst layer may cover a surface of the oxygen electrode 6 which contacts the electrolyte 8. A purpose of the electrocatalyst layer 10 is to promote electrochemical reactions that can be used by the battery 2 to produce electric power.

In an embodiment, a separator 10 is positioned in the electrolyte 8 and between the zinc electrode 4 and the oxygen electrode 6. A purpose of the separator 10 is to provide physical isolation between the electrodes 4 and 6 to prevent shorting and to separate the electrode reactions from one another. Ions may pass through the structure of the separator 10 to allow for current flow.

In an embodiment, the zinc electrode 4 and the oxygen electrode 6 are both electrically coupled to an electric component 14. In a discharge mode of the battery 2, the electric component 14 may be a component which uses electricity, such as, for example, a light bulb, electric machine, etc. In a charge mode of the battery 2, the electric component 14 may be a component which generates or supplies electricity, such as, for example, a power supply. The following briefly describes the operation of the battery 2 during discharge, following which is included a brief description of the operation of the battery 2 during charge.

In an embodiment, during discharge, the oxygen electrode 6 acts as a cathode and the zinc electrode 4 acts as an anode. The oxygen electrode 6 is exposed to air such that oxygen (O₂) in the air comes into contact with the cathode and reacts with it forming hydroxyl ions (OH⁻). These ions migrate through the electrolyte 8 to the anode. At the anode, the electrolyte 8 is saturated with zinc (Zn) from the zinc electrode 4. The ions combine with the zinc saturated electrolyte 8 to form zincate (Zn(OH)₄²⁻). Formation of the zincate at the anode causes a release of electrons (2e⁻) which generate a voltage. These electrons produce an electric current by travelling from the anode to the cathode via the electric component 14. In this way, electric power is provided to the electric component 14, for example, the light bulb is illuminated or turned-on. The zincate decays into zinc oxide (ZnO), and water (H₂O) is returned to the electrolyte 8 which is recycled with the hydroxyl at the cathode. During discharge, the reactions at the oxygen electrode 6 are termed oxygen reduction reactions (ORR).

In an embodiment, during charge, the oxygen electrode 6 acts as an anode and the zinc electrode 4 acts as a cathode. The reactions are reversed during charge and oxygen gas is evolved at the anode 6, whereas Zn is deposited at the cathode 4. During charge, the reactions at the oxygen electrode 6 are termed oxygen evolution reactions (OER).

In an embodiment, the oxygen electrode 6 is a bifunctional oxygen electrode. Specifically, the oxygen electrode 6 is bifunctional because it can be used for both oxygen reduction and oxygen evolution reactions.

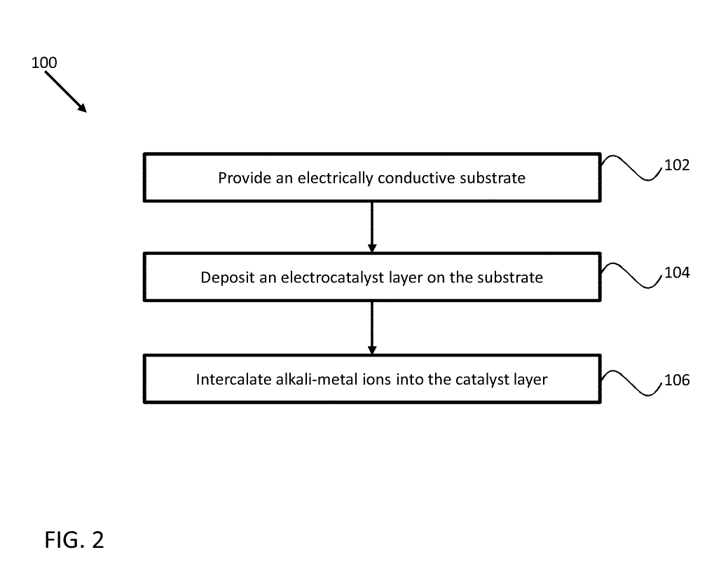

FIG. 2 illustrates a method 100 for manufacturing the oxygen electrode 6. At block 102, an electrically conductive substrate is provided. In an embodiment, the substrate has a high surface area, for example, due to having a rough outer texture or by being porous. In one embodiment, the substrate may include carbon nanotubes or graphene. In other embodiments, the substrate may be carbon cloth, carbon fiber paper, graphite felt, metal mesh (such as nickel or titanium mesh), metal foam (such as nickel or titanium foam), or reticulated vitreous carbon.

At block 104, an electrocatalyst layer is deposited onto the substrate. The electrocatalyst layer may comprise at least one of the following: manganese oxide, a perovskite, and an oxide having a fluorite-related structure. The perovskite can be lanthanum cobalt oxide with the formula LaCoOₓ, where x is between 0.1 to 5. Alternatively, the perovskite can be lanthanum nickel oxide with the formula LaNiOₓ. where x is between 0.1 to 5. The oxide having the fluorite-related structure can be neodymium iridium oxide with the formula NdₓIrO_{y}, where x is between 0.1 to 5 and y is between 0.1 to 10. For example, the perovskite may be LaCoO₃, and the oxide having a fluorite-related structure may be Nd₃IrO₇. In one particular embodiment, the electrocatalyst layer is MnO₂—LaCoO₃ or MnO₂—Nd₃IrO₇.

In an embodiment, deposition includes depositing the electrocatalyst layer with a surfactant on the substrate using an anodic electrodeposition process. The surfactant may include sodium dodecyl sulfate, hexadecyl-trimethyl-ammonium bromide, and/or Triton X-100.

In an embodiment, the anodic electrodeposition process is performed at a temperature of between 295K and 343K, for example, at 295K, 319K or 343K. In an embodiment, the anodic electrodeposition process is performed at an anodic potential of between 800 mV and 2000 mV vs. a mercury/mercury oxide (Hg/HgO) reference electrode (MOE), for example, at 800 mV_{MOE}, 1200 mV_{MOE} or 1600 mV_{MOE}. In an embodiment, the anodic electrodeposition process is performed using a liquid bath having a surfactant concentration of between 0% vol and 30% vol, for example, 0% vol, 5% vol or 10% vol. In an embodiment, the anodic electrodeposition process is performed using a liquid bath having a manganese (II) ion concentration of between 0.1M and 3M, for example, 0.1M, 0.2M or 0.3M. In another embodiment, the anodic electrodeposition process is performed using a liquid bath having a cobalt (II) or nickel (II) ion concentration of between 0.001M and 3M. When the anodic electrodeposition process involves a lanthanum-containing perovskite, the concentration of lanthanum (III) ions during the anodic electrodeposition process can be between 0.001 M and 3M. Lanthanum diffusion into the catalyst layer can be performed electrophoretically at a constant cathodic current density between −1 to −100 mA cm⁻².

At block 106, alkali-metal ions are intercalated into the catalyst layer by potential driven intercalation in which the alkali-metal ions are provided by an alkali-metal salt dissolved in an aqueous solution and using also a counter electrode. In an embodiment, the potential driven intercalation is performed at a constant cathodic current density of −5.4 mA cm⁻². In an embodiment, the alkali-metal is any one of the following: potassium, lithium, sodium, or cesium.

In an embodiment, prior to depositing an electrocatalyst layer on the substrate, the substrate may be pretreated using an acidic solution, such as nitric acid, acetic acid, phosphoric acid, sulfuric acid or combinations thereof. Additionally or alternatively, prior to intercalating alkali-metal ions into the catalyst layer, the substrate having the electrocatalyst layer deposited thereon may be post-treated by washing in isopropyl alcohol.

In an alternative embodiment, rather than using anodic electrodeposition, an electrocatalyst ink maybe sprayed onto the substrate to deposit the electrocatalyst layer on the substrate. The electrocatalyst ink comprises at least one component selected from a group consisting of: manganese oxide particles, lanthanum cobalt oxide particles, lanthanum nickel oxide particles, neodymium iridium oxide particles, carbon particles, graphene flakes, nitrogen-doped graphene flakes, graphite fibers, graphite particles, multi walled carbon nanotubes, single walled carbon nanotubes, acetylene black, Nafion® resin solution or powder, polytetrafluoroethylene (PTFE) powder or suspension, and water and isopropyl alcohol.

In an alternative embodiment, rather than using potential driven intercalation, an open circuit intercalation process may be used in which the alkali-metal ions are provided by a solution in contact with the substrate without applying a potential difference between the anode and cathode of the cell.

In an embodiment, the oxygen electrode manufactured in accordance with the above-described process may be used as an oxygen electrode in a metal-air battery, such as the one shown in FIG. 1. Additionally, the oxygen electrode may be used as an oxygen electrode of one or more of the following: a regenerative H₂—O₂ fuel cell, a direct fuel cell, a redox flow battery, and an electrochemical cell.

The following provides a detailed description of specific embodiments. First, a detailed explanation of an embodiment relating to blocks 102 and 106 is provided, under the heading ‘Enhancing the Bifunctional Activity and Durability of Oxygen Electrodes with Manganese Oxide Catalyst’. Second, a detailed explanation of an embodiment relating to block 104 is provided, under the heading of ‘Surfactant-assisted Electrodeposition of Manganese Oxides’.

Enhancing the Bifunctional Activity and Durability of Oxygen Electrodes with Manganese Oxide Catalyst.

Highly active and durable bifunctional oxygen electrodes catalyzing both the oxygen reduction (ORR) and oxygen evolution (OER) reactions are important for the development of rechargeable metal-air batteries (e.g., Zn-air, Al-air, Mg-air, Li-air) and regenerative H₂—O₂ fuel cells _ENREF_1. Noble metals and their alloys such as Pd, Ag, Pt, Pt—Au and Pt—Co have been investigated for ORR in alkaline media but their lower electrocatalytic activity toward OER_ENREF_13_ENREF_14 as well as higher price compared to perovskite-type oxides (e.g., LaNiO₃ and LaCoO₃) and Co oxides, limit their widespread use as cost effective bifunctional oxygen electrode catalysts. Moreover, other noble metals and their oxides such as Ru, Ir, RuO₂ and IrO₂, which are known as for use as an OER electrocatalyst, exhibit comparatively poor ORR electrocatalytic activity, thus, preventing their deployment as bifunctional oxygen electrocatalysts.

Diverse manganese oxides are cost-effective electrode materials for a variety of applications including primary and secondary batteries, ORR catalysts for alkaline fuel cells and electric double-layer capacitors. The γ-MnO₂, which is believed to be an intergrowth of pyrolusite (β-MnO₂) in the ramsdellite (α-MnO₂) matrix, is among the most electrocatalytically active forms of manganese oxides for ORR in alkaline media, generating an ORR Tafel slope of 40 mV dec⁻¹ and an overpotential of −375 mV (at −2 mA cm⁻²). In addition to the intrinsic electrocatalytic activity, the performance of the catalyst layer is also greatly influenced by the presence or absence of a catalyst support. The effect of carbon black support on the ORR performance of α-MnO₂ nanowires is such that 30% wt MnO₂ on Vulcan XC-72 provides a high ORR current density. Moreover, nitrogen doped carbon nanotubes and reduced graphene oxide (RGO) supports lower the ORR overpotentials of MnOₓ catalysts. Thus, in practical gas-diffusion electrodes the apparent electrocatalytic activity and durability is a complex function of the intrinsic kinetic activity of the catalyst in conjunction with the other components of the catalyst layer (i.e., support type and structure, hydrophobic agent and ionomer).

In addition to MnOₓ another important class of non-precious metal oxygen electrode electrocatalysts are perovskites, with the general formula of ABO₃ (where A and B correspond to rare-earth metal and transition-metal ions, respectively, with various ions and valances in their structure). Different types of perovskites including La_{0.6}Ca_{0.4}CoO₃, Sm_{0.5}Sr_{0.5}CoO_{3-δ}, LaNiO₃, LaCoO₃ and _ENREF_49 layered La₃Sr₃Fe₃O₁₀ show promising electrocatalytic activity for OER in alkaline electrolytes. However, many perovskites exhibit poorer ORR electrocatalytic activity compared to MnOₓ.

Oxides with a fluorite-related structure, such as Nd₃IrO₇ with an orthorhombic structure (space group Cmcm), can also be used as bifunctional oxygen electrode catalysts. Tafel slopes and exchange current densities for OER of 25 mV dec⁻¹ and 1.5×10⁻¹⁵ μA cm⁻², respectively, and 63 mV dec⁻¹ and 8.5 μA cm⁻² for ORR, are obtainable in 45% wt KOH. The low exchange current density for OER compared to ORR renders unlikely the practical possibility of using Nd₃IrO₇ or other IrO₆ or IrO₇-containing compounds as a lone bifunctional catalyst.

The present approach has been to investigate mixed oxides based on MnO₂ in conjunction with K⁺ promotion of the catalytic activity and durability. The combination of γ-MnO₂ with perovskites (LaNiO₃ or LaCoO₃) produces a synergistic bifunctional catalytic effect, and a possible catalytic ‘healing’ effect of electrodes subjected to accelerated degradation induced by an uptake of potassium ions under open-circuit conditions. The objectives are two-fold. First, to compare two structurally different mixed oxide formulations: MnO₂—LaCoO₃ (perovskite) and MnO₂—Nd₃IrO₇ (fluorite-related) and second, to study the specificity of the K⁺ promotion effect on both the initial stage activity and electrocatalytic durability.

LaCoO₃ and Nd₃IrO₇ Synthesis and Characterization

LaCoO₃ powder was synthesized via a co-precipitation method, such as, as described in P. H. Benhangi, A. Alfantazi and E. Gyenge, Electrochimica Acta, 123, 42 (2014). Nd₃IrO₇ was made by a direct solid-state synthesis method, such as, as described in J. F. Vente and D. J. W. Ijdo, Materials Research Bulletin, 26, 1255 (1991) http://www.sciencedirect.com/science/article/pii/S0013468613025425?np=y-bib0090. Neodymium (III) oxide and iridium metal powders were mixed with a molar ratio of 1:1 in a glass mortar. The mixture was then heated for 12 hrs at 1323 K in an oxygen atmosphere using a tube furnace and then left to cool down to room temperature in the furnace. Afterwards, the sample was grinded and heated again for 15 hrs at 1323 K under oxygen. The last step was cooling down the sample in the furnace. The heating rate for all segments was 5 K min⁻¹. To avoid pyrochlore-type compound formation, i.e., Nd₂Ir₂O₇, the oxygen atmosphere was used during heat treatments.

Detailed morphological characterization by SEM and TEM and structural analysis by XRD and EDX of the synthesized LaCoO₃ and Nd₃IrO₇ was performed (results not presented here). The particle size ranges for LaCoO₃ and Nd₃IrO₇ are between 50-100 nm and 100-200 nm, respectively.

Gas Diffusion Electrode (GDE) Preparation

Five catalyst compositions were comparatively investigated: two mixed oxide formulations MnO₂—LaCoO₃ and MnO₂—Nd₃IrO₇, respectively, and three individual oxides LaCoO₃, Nd₃IrO₇ and MnO₂. The electrode loading for each of the oxide catalysts was 0.5 mg cm⁻². In addition to the oxide(s), the catalyst layer also contained Vulcan XC-72 in a 1:1 weight ratio with the oxide(s). Vulcan XC-72 enhances the electronic conductivity in the oxide-based catalyst layers but it is also catalytically active for the two-electron ORR in alkaline media. MnO₂ can be purchased from Sigma-Aldrich, whereas the LaCoO₃ and Nd₃IrO₇ were synthesized as presented above. The Sigma-Aldrich MnO₂ structurally is a γ-MnO₂ (i.e., intergrowth of pyrolusite (β-MnO₂) into a ramsdellite (α-MnO₂) matrix) and has higher ORR electrocatalytic activity compared to other commercially readily available MnO₂ samples.

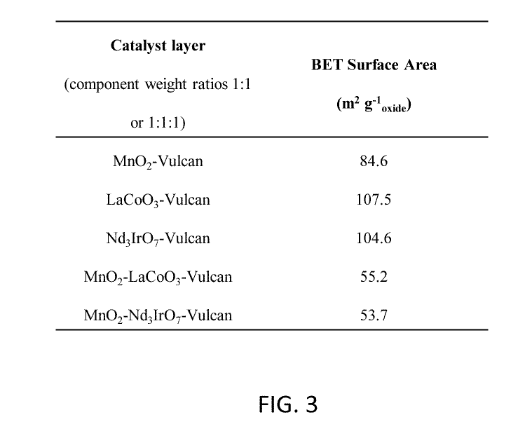

The BET surface areas of the catalyst layers containing Vulcan XC-72 are reported in FIG. 3. The mixed oxide formulations have very similar BET surface areas between 53.7 and 55.1 m² g⁻¹.

Catalyst inks were prepared by 1 hr sonication of the mixture composed of the oxide(s), Vulcan XC-72, isopropanol, water, 5% wt Nafion solution and 60% wt polytetrafluoroethylene (PTFE) suspension. The Vulcan:isopropanol:water weight ratio was fixed at 1:50:16 in all catalyst inks based on our previous studies aimed at finding the right catalyst ink composition for spraying using our CNC sprayer machine. The PTFE and dry Nafion content of the catalyst layer was the same, namely, 0.3 mg cm⁻² each, for all samples. The catalyst inks were sprayed on a 4×4 cm (16 cm² geometric area) piece of 40% wt PTFE treated carbon cloth from Fuel Cell Earth Co. to achieve MnO₂ and co-catalyst (LaCoO₃ or Nd₃IrO₇) loadings of 0.5 mg cm⁻² each.

Electrochemical Measurements

The bifunctional electrocatalytic activity and durability of the GDE was tested in a half-cell setup. A punch-cut circular GDE sample of 0.8 cm diameter was used in a quick-fit exchangeable sample holder from Radiometer Analytical (#A35T450) to provide a geometric electrode area of 0.283 cm² in a rotating disk electrode (RDE) setup. Cyclic voltammetry and galvanostatic polarization experiments were performed in O₂ saturated 6 M KOH at 293 K with the GDE as working electrode, Hg/HgO/0.1 M KOH as reference electrode and Pt mesh as counter electrode. The electrodes were connected to a computer-controlled VoltaLab 80 potentiostat and its associated RDE setup. The potential of Hg/HgO/0.1 M KOH (abbreviated as MOE) reference electrode was 932.8 mV vs. RHE in 6 M KOH at 293 K measured using the reversible hydrogen reference electrode (HydroFlex) from Gaskatel GmbH. All potentials are reported vs. RHE unless otherwise specified. The equilibrium oxygen electrode potential in 6 M KOH was calculated to be 1173 mV_{RHE} or 241.2 mV_{MOE}.

Prior to the reported electrocatalytic performance tests, each electrode was subjected to a break-in polarization protocol composed of five potential cycle between 233 and 1683 mV at 5 mV s⁻¹ and 400 rpm, starting with anodic polarization. Afterwards, cyclic voltammetry was performed in the same potential for up to one hundred successive cycles. Voltammograms used for calculating electrode kinetic parameters were repeated at least six times. For galvanostatic polarization tests (i.e., chronopotentiometry) a constant current density (per geometric area) of 5 mA cm⁻² was applied for 2 hrs in the OER region while −2 mA cm⁻² was used in the ORR region for 30 min.

All cyclic voltammograms and galvanostatic polarization plots are IR-corrected using the “Static Manual” ohmic drop compensation feature of VoltaLab 80 potentiostat.

K⁺ Intercalation and Promotion

Two methods of K⁺ promotion are investigated: open-circuit and potential driven (electrophoretic) intercalation, respectively. In the open-circuit potential (OCP) method, each GDE was kept in the 6 M KOH solution for six days at 313 K under a rotation speed of 400 rpm. The samples were then thoroughly washed in 18 mΩ DI water for further electrochemical investigations. The same OCP method was also applied using LiOH, NaOH and CsOH to study comparatively the effect of exposure of the oxide catalysts to diverse alkali ions.

In the potential driven intercalation (PDI) method, a constant cathodic current density of −5.4 mA cm⁻² was applied for 30 min. to the electrodes under investigation in the RDE setup (at 400 rpm) in a 0.036 M K₂SO₄ solution at 343 K. The cathodic current density was selected so as to provide the necessary potential gradient for K⁺ migration toward the cathode while avoiding excessive H₂ gas evolution. A platinum plate was used as a counter electrode. The samples were then thoroughly washed in 18 mΩ DI water before further electrochemical investigations. The PDI procedure was repeated up to seven times to investigate the cumulative effect of the treatment method on the bifunctional performance. Each repeated PDI treatment was carried out using fresh K₂SO₄ solution.

Characterization

The catalyst powders as well as GDEs (before and after OCP or PDI activation methods) were characterized by one or more of the following techniques: X-ray diffraction (XRD, D8 Advance Bruker diffractometer with a CuK_{α1} source), X-ray photoelectron spectroscopy (XPS, Leybold Max 200 and Kratos AXIS Ultra), energy dispersive X-ray analysis (EDX, Hitachi S-2600N variable pressure scanning electron microscope (VPSEM) equipped with an X-ray detector), electron energy loss spectroscopy (EELS, FEI Titan 80-300 LB equipped with a energy loss spectrometer Gatan 865 model), field emission scanning electron microscopy (FESEM, Hitachi S-4700) and transmission electron microscope (TEM, FEI Tecnai G2 200 kV). The XPS source was monochromatic Al K_{α}. The EDX accelerating voltage was 10 kV. The operating conditions for XRD were as follows: generator set at 40 kV and 40 mA; Cu as X-ray source; wave length of 1.54439 Å K_{α1}; step size of 0.04° (2θ); step time of 230.4 s; range: between 5° to 90° for 2θ.

Results and Discussion

Initial Stage Bifunctional Activities without K⁺ Promotion

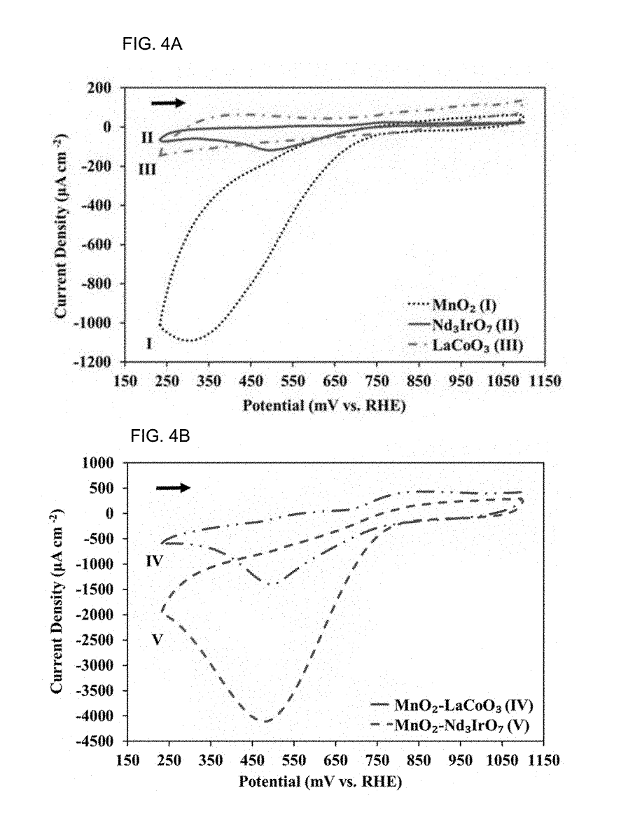

FIGS. 4A and 4B present the cyclic voltammograms of the investigated oxide electrodes recorded in N₂ saturated 6 M KOH. The upper potential limit in FIGS. 4A and 4B was selected such that to be lower than the oxygen equilibrium potential in order to reveal at this stage only the intrinsic responses of the oxides themselves and to avoid as much as possible interferences by dissolved oxygen. The reduction waves for MnO₂ and Nd₃IrO₇ reach their respective peak currents at 300 and 500 mV, respectively (FIG. 4A). For iridium oxide compounds with structures related to Nd₃IrO₇, similar voltammetry response to that shown by FIG. 4A at high pH was attributed to the Ir⁵⁺/Ir⁴⁺ couple. The reduction onset potential for both MnO₂ and Nd₃IrO₇ is the same, about 750 mV. Compared to MnO₂ and Nd₃IrO₇, either oxidation or reduction waves associated with LaCoO₃ are virtually absent (FIG. 4A), corroborating previous reports of sluggish intrinsic electron transfer to or from LaCoO₃.

For both mixed oxide formulations (FIG. 4B), the reduction peak potential was about 480 mV, which is characteristic mainly for Mn⁴⁺/Mn³⁺ reduction as opposed to Mn³⁺/Mn²⁺ reduction occurring at lower potentials (e.g., 300 mV FIG. 4A). Furthermore, the reduction current densities for the mixed oxides were larger than for each of the individual components, suggesting more extensive reduction in the catalyst layer (of mostly MnO₂ and Nd₃IrO₇ where applicable).

With regard to FIGS. 4A and 4B, it is noted that the electric double-layer portion of cyclic voltammograms for various oxides was used to estimate the electrocatalytic surface area (ECSA) of these oxide catalysts. However, equating the total charged surface area obtained from electric double-layer capacitance measurements with the area of bifunctionally active sites for oxides with complex structure and involving various oxidation states with different activities, is unwarranted. In such cases, with respect to ECSA, the area obtained from electric capacitance measurements is hardly more accurate than the total BET area (FIG. 3). Hence, none of them are utilized here to represent the ECSA.

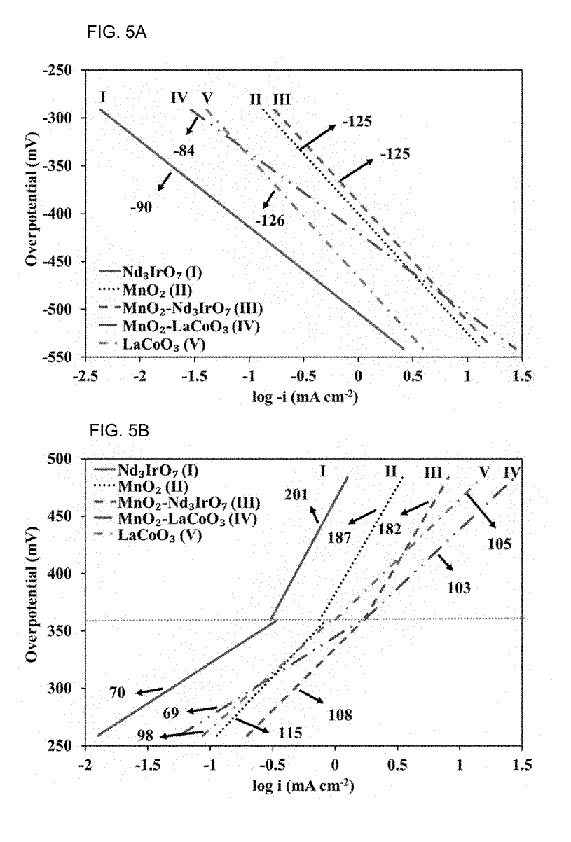

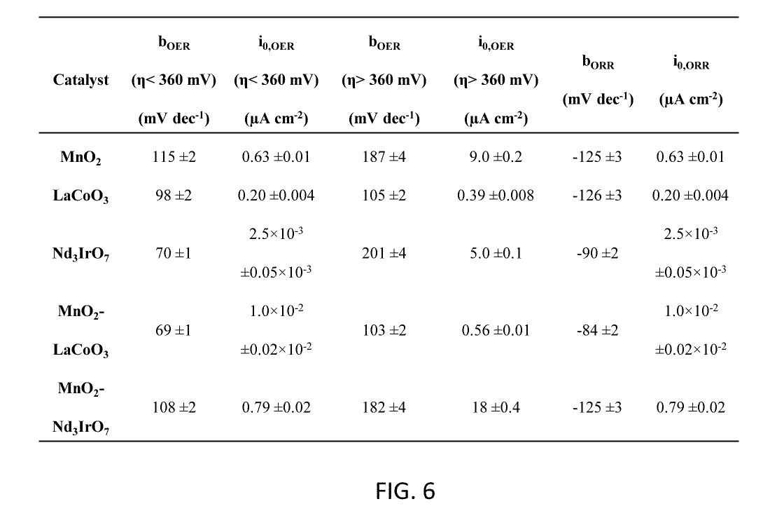

Next, polarization curves for ORR and OER were recorded by potential scanning between 233 to 1683 mV in O₂ saturated 6 M KOH at 293 K, with a scan rate of 5 mV s⁻¹. The results, representative for the initial stage catalytic activity, are presented as Tafel plots in FIGS. 5A and 5B, whereas FIG. 6 summarizes the calculated apparent exchange current densities and Tafel slopes. With respect to ORR, among the individual oxides, MnO₂ had the highest activity, followed by LaCoO₃ and lastly Nd₃IrO₇ (FIG. 5A). Considering for comparison an overpotential of −350 mV, the ORR current density (reported per geometric area) on MnO₂ was 3.3 and 20 times higher than on LaCoO₃ and Nd₃IrO₇, respectively. Furthermore, the combination of MnO₂ with Nd₃IrO₇ (in a 1:1 weight ratio) increased the apparent exchange current density compared with either of the individual oxides, i.e., by almost 26% vs. MnO₂ alone and by over two-orders of magnitude vs. Nd₃IrO₇ alone (FIG. 6). The Tafel slope of the mixed oxide MnO₂—Nd₃IrO₇ catalyst remained virtually the same as for MnO₂ alone. The synergistic effect between MnO₂ and Nd₃IrO₇ impacting the apparent exchange current density brought about the highest initial stage ORR current densities among the investigated catalysts in case of overpotentials greater than −500 mV (FIG. 5A). At overpotentials lower than −500 mV, the MnO₂—LaCoO₃ combination prevailed due to lower Tafel slope, i.e., −84 mV dec⁻¹ vs. −125 mV dec⁻¹ for MnO₂—Nd₃IrO₇ (FIG. 5A).

In the OER part of the polarization curve, the Tafel lines and the associated kinetic parameters are potential dependent (FIG. 5B and FIG. 6), a known phenomenon usually attributed to changes in the rate determining step. At overpotentials lower than 360 mV, the apparent Tafel slopes were between 70 mV dec⁻¹ (Nd₃IrO₇) and 115 mV dec⁻¹ (MnO₂), whereas above 360 mV the Tafel slopes varied between 103 mV dec⁻¹ (MnO₂—LaCoO₃) and 201 mV dec⁻¹ (Nd₃IrO₇). In the high overpotential region, abnormal Tafel slopes such as between 182 to 201 mV dec⁻¹ in FIG. 5B, have been reported by others as well, and it is due to hampered growth and detachment of O₂ gas bubbles. In other words, at high overpotentials, there are many surface sites available for gas bubble nucleation but due to surface irregularities and other morphological features of the porous electrode causing entrapment, the bubble growth and break-off are inhibited, thereby, shielding the catalytic surface. These effects are manifested as abnormally high apparent Tafel slopes in polarization experiments at high overpotentials.

Considering as basis for comparison an OER current density of 10 mA cm⁻² as per the benchmarking study of C. C. L. McCrory, S. Jung, J. C. Peters and T. F. Jaramillo, Journal of the American Chemical Society, 135, 16977 (2013), the corresponding overpotentials on the mixed oxide catalysts were 440 mV on MnO₂—LaCoO₃ and 501 mV on MnO₂—Nd₃IrO₇ (FIG. 5B). The latter overpotentials, representative for the initial stage activities, are significantly lower than for any of the individual oxides investigated, demonstrating clearly a strong beneficial synergistic electrocatalytic effect between the two components. FIG. 6 reveals that in the low OER overpotential region, the combination of MnO₂ with LaCoO₃ decreased the Tafel slope to 69 mV dec⁻¹ from 115 and 98 mV dec⁻¹, respectively, whereas the combination of MnO₂ with Nd₃IrO₇ increased the exchange current density from 0.60 μA cm⁻² for MnO₂ to 0.79 μA cm⁻² for MnO₂—Nd₃IrO₇.

The prevailing modern theoretical concept regarding the oxygen electrode mechanism is based on the scaling relationships, indicating that the binding energies of intermediates, such as HOO* and HO*, are linearly correlated regardless of the binding site. Hence, both species adsorb on the same sites on the oxide surface with a single bond between O and the surface. This so-called universal scaling relationship leads to a theoretical minimum overpotential of about 370 mV for the OER for model oxide surfaces with (110) orientation. The practical translation of these results for “designing” the oxide catalytic surfaces is complicated by the fact that the synthesized oxides, such as MnO₂, have a very complex crystallographic structure (ranging from α to ε), with the possibility of intertwined structures, numerous types of vacancies, disorders and lattice defects and changes in the oxidation states during battery cycling. In spite of the virtual impossibility of considering all these effects in a first principles model, a comparison between theoretically calculated and experimentally measured initial stage OER and ORR current densities for α-Mn₂O₃ showed promising fit especially in the ORR region, whereas some deviations are noted in case of OER. The MnO₂ used in the present work is of γ-type, which is a combination of α and β structures, and it was previously shown to provide good ORR activity compared to other commercial sources of MnO₂. Theoretical studies suggest the need to break the scaling relationship between the HOO* and HO* binding energies in order to improve the bifunctional activity by favoring weaker HO* binding. It is hypothesized that combining oxides with different structural features such as MnO₂ and perovskite or MnO₂ with fluorite-type structures, provides different binding sites and binding energies for HOO* and HO*, that contribute to the observed synergistic electrocatalytic effect presented by FIGS. 5A and 5B, and FIG. 6.

Oxide Catalyst Layer Activation by K⁺ Intercalation

As mentioned above, there is a catalytic “healing” effect of MnO₂-perovskite electrodes subjected to accelerated degradation (i.e., extensive potential cycling between the OER and ORR regions) by long-term (i.e., up to six days) exposure at open-circuit to 6 M KOH. It was proposed, based on XPS results, that K⁺ insertion in the catalyst structure is responsible for the recovery of the bifunctional electrocatalytic activity. Here, the concept of oxide activation by K⁺ is further advanced by considering the following questions: i) is the effect specific to K⁺ or other alkali-metal ions produce similar effects?, ii) can also the initial stage bifunctional activity improved by activation and is this effect durable?, and iii) instead of long-term exposure at open-circuit what other time-efficient methods for activation could be developed?

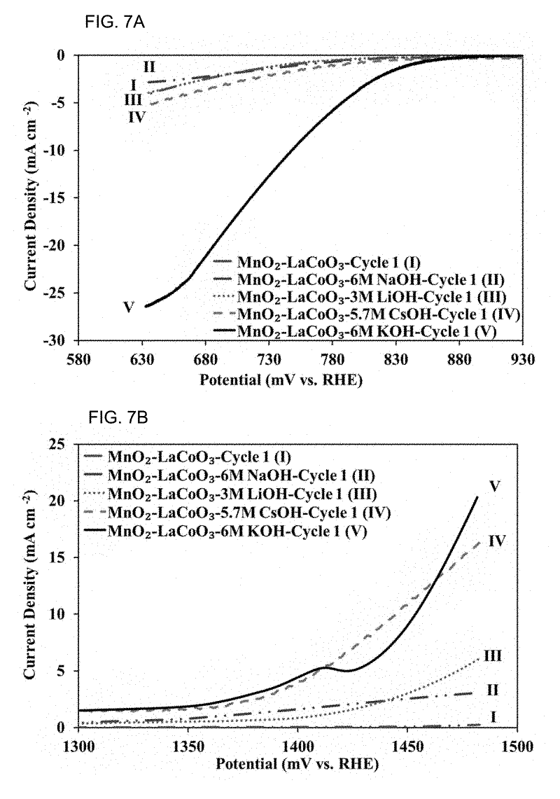

FIGS. 7A and 7B show the bifunctional polarization curves of MnO₂—LaCoO₃ recorded after six days of exposure to alkali-metal hydroxide solutions with concentrations near their respective ionic conductivity maximum. With respect to ORR (FIG. 7A), clearly KOH induced the most significant activity improvement. At a potential of 730 mV, an ORR current density of −12.5 mA cm⁻² was obtained, whereas in case of exposure to any of the other hydroxides and for the unactivated sample, the current density was at least three times lower, indicating a high level of K⁺ specificity. These results are corroborated by a different type of investigation, where the ORR on LaMnO₃ was comparatively studied in either 0.1 M LiOH, or 0.1 M NaOH or 0.1 M KOH. The ORR current density increased with increasing cation size in the electrolyte. It was proposed that the alkali metal ion may influence the rate determining step by interacting with the O₂²⁻ species formed on the oxide surface. The smaller the cation size the stronger this interaction, inhibiting therefore, the ORR rate determining step. However, FIGS. 7A and 7B show that in the present case the performance with six days exposure or without exposure to LiOH are virtually the same. Thereby, there is no evidence of ORR inhibition by Li⁺. Furthermore, exposure to Cs⁺ produces only a minor ORR improvement compared to K⁺, suggesting that no simple linear correlation can be established based on cation size.

In the OER section of the polarization curve (FIG. 7B), extended exposure to all the alkali metal hydroxides increased the current density compared to the unactivated case. However, the best results were obtained in the presence of K⁺ and Cs⁺ ions. At a potential of 1450 mV, the OER current density on the MnO₂—LaCoO₃ electrode was about an order of magnitude higher after the electrode was exposed to either KOH or CsOH. In the case of MnO₂—Nd₃IrO₇ as well, the exposure to KOH produced a similarly remarkable increase of the OER current density (results not shown). While some degree of non-specific contribution in FIG. 7B cannot be completely ruled out, where the longer-term exposure to any alkali metal hydroxide solution could render the electrode more hydrophilic (e.g., partial PTFE wash-out), hence, a higher fraction of the pores are available for electrolyte penetration and oxygen evolution, FIGS. 7A and 7B together point to a distinct bifunctional promotion effect mainly by K⁺ and to some extent by Cs⁺.

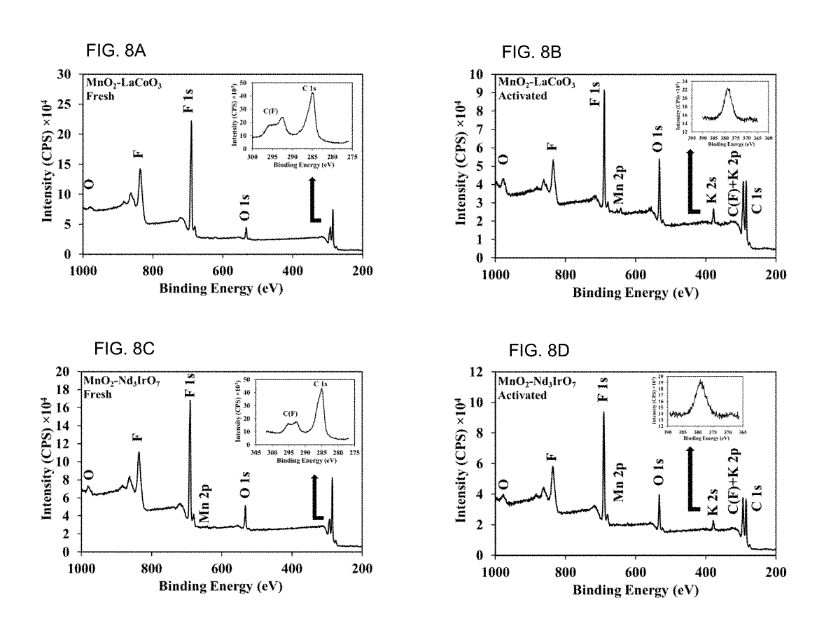

To gain further insights in the K⁺ promotion effect as revealed by electrode polarization experiments (FIGS. 7A and 7B), the XPS spectra of both fresh and K⁺ activated MnO₂—LaCoO₃ and MnO₂—Nd₃IrO₇ catalysts is presented (FIGS. 8A to 8D).

The Mn and La major peaks overlap with the ones corresponding to F at about 690 and 835 eV, respectively (FIGS. 8A to 8D). Fluorine is one of the main constituents of both the carbon cloth substrate (due to teflonation) and catalyst layer (due to Nafion ionomer and PTFE). Furthermore, the Nd major peaks around 980 eV overlap with O (FIGS. 8C and 8D).

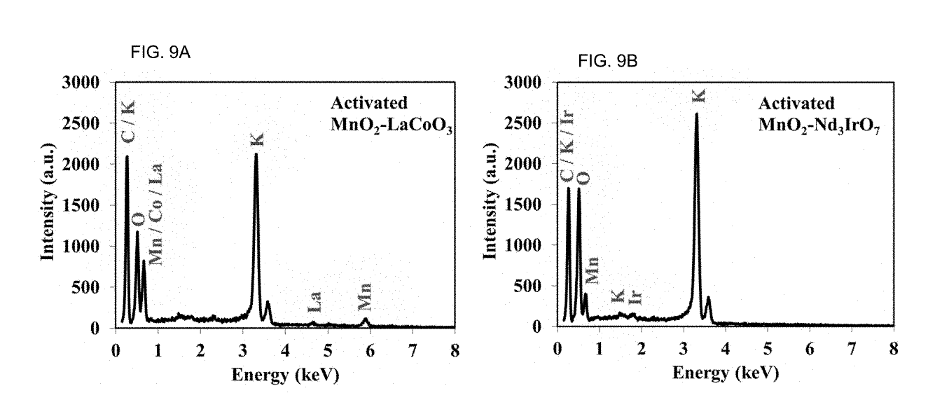

Comparing the XPS spectra for fresh and K⁺ activated catalysts, the latter reveal peaks around 379 eV which correspond to K 2s. Two major spin-orbit splitting peaks appear for K 2p around 290 eV, but these peaks also overlap to large extent with the ones from C(F) and C is due to the carbon material in both substrate and catalyst layer (FIGS. 8A to 8D). The presence of potassium has been also confirmed by the EDX spectra of the activated catalyst layers (FIGS. 9A and 9B).

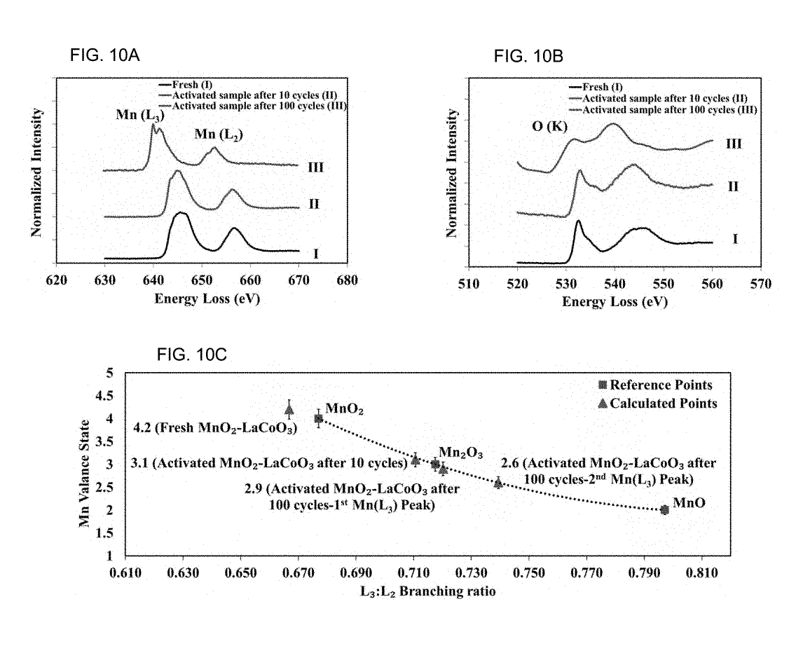

The intercalation of K⁺ in MnO₂ could be understood in terms of the cation vacancy model. During electrode potential cycling between the ORR and OER regions, the fraction of Mn⁴⁺ and Mn³⁺ ions is changing, as shown also by electron energy loss spectroscopy (EELS) in FIGS. 10A to 10C. The first charge-transfer process associated with MnO₂ can be represented as:

Mn₍ₛ₎⁴⁺+2O₍ₛ₎²⁻+e⁻+H₂O→Mn₍ₛ₎³⁺+O₍ₛ₎²⁻+OH₍ₛ₎⁻+OH_{(aq)}⁻ (1)

Thus, one electron and one proton is inserted per MnO₂ leading to the formation of OH⁻₍ₛ₎ and Mn³⁺₍ₛ₎ with lattice expansions. Generally, the composition of partially reduced γ-MnO₂ can be described as:

Mn_{1-x-y}⁴⁺.Mn_{y}³⁺.O_{2-4x-y}²⁻.Vₓ^{///}.OH_{4x+y}⁻ (2)

where x is fraction of vacancies, y is fraction of Mn³⁺ ions and V^{///} represents a cation vacancy in the Schottky notation.

In light of the cation vacancy model and Eq. (2), it seems plausible that K⁺ could intercalate into the vacancies, also known as Schottky defects, surrounded by OH⁻ ions. This intercalation may cause lattice distortion since the ionic radius of Mn⁴⁺ ions is much smaller than the one for K⁺, i.e., 53 and 137 pm, respectively. It is proposed that the lattice distortions induced by K⁺ affect the binding energies of intermediate species involved in ORR and OER, respectively, contributing to the enhanced bifunctional activity. In future, studies experimental evidence corroborated possibly by theoretical calculations of the binding energies of relevant intermediate species on MnO₂ with and without lattice distortions is required to validate the proposed hypothesis.

During potential cycles between ORR and OER regions, diverse MnOₓ phases are forming with different activity and stability causing an overall complex behavior influencing the electrode durability. An effective way to find the Mn valance would be important to unveil the MnOₓ associated with different stages of ORR and OER. While X-ray photoelectron spectroscopy (XPS) can help determine the Mn valance using the Mn 3s peak separation method in the presence of pure MnOₓ, EELS is more effective for Mn valance determination when it comes to complex systems such as bifunctional catalyst layers with more than one component. EELS was performed on MnO₂—LaCoO₃ catalyst in three different conditions (FIGS. 10A to 10C): I) fresh catalyst, II) K⁺ activated catalyst after being cycled for ten cycles between 633 and 1483 mV in O₂ saturated 6 M KOH at 293 K and 400 rpm, and III) K⁺ activated catalyst after being cycled for one hundred cycles between 633 and 1483 mV in O₂ saturated 6 M KOH at 293 K and 400 rpm. The latter is representative for an accelerated electrode degradation protocol.

FIGS. 10A to 10C show the EELS spectra for manganese L edges and oxygen K edges as well as the calculated Mn valances for the MnO₂—LaCoO₃ catalysts during different stages of cycling. FIG. 10A indicates that not only the shape of Mn(L_{2,3}) peaks changed during the durability testing but also the position shifted after being cycled. The Mn(L₃) main peak for MnO₂—LaCoO₃ catalyst shifted from 645.8 to 639.9 eV after one hundred cycles of durability testing (FIG. 10A). The O(K) main peak, however, fluctuates around 532 eV for both the fresh sample and the ones subjected to one hundred cycles. According to the literature, the shifts in the Mn(L₃) and O(K) main peaks could be related to change of the MnOₓ species from MnO₂ to Mn₂O₃ and Mn₃O₄ after being cycled for one hundred cycles.

The shape of each Mn(L_{2,3}) and O(K) edges can also represent the type of manganese oxide present in the catalyst layer. The Mn(L_{2,3}) and O(K) edges of the fresh MnO₂—LaCoO₃ catalyst in EELS spectrum is similar to the one shown in the literature for MnO₂ (FIGS. 10A and 10B). After the K⁺ activation and ten cycles, the EELS spectrum of the MnO₂—LaCoO₃ sample is similar to that of Mn₂O₃ reported in the literature, especially the Mn(L₃) and O(K) peaks at 644.8 and 532.9 eV, respectively (FIGS. 10A and 10B). The Mn (L_{2,3}) edges of the activated MnO₂—LaCoO₃ after being cycled for ten cycles could be due to MnOOH.

Furthermore, the activated MnO₂—LaCoO₃ catalyst after one hundred cycles shows the typical EELS spectrum of Mn₃O₄, reported in the literature, with two Mn(L₃) and one O(K) peaks at 639.9, 641.3 and 531.7 eV, respectively (FIGS. 10A and 10B). The Mn₃O₄ doublet peaks could be further deconvoluted to Mn(L₃) edges from MnO to Mn₂O₃ or MnOOH (FIG. 10A) _ENREF_59. It has been reported that the ratio of Mn(L₃) peaks corresponding to Mn³⁺ and Mn²⁺, in the present case 1.1 after one hundred cycles, could indicate the presence of vacancies in the tetrahedral sites of the Mn₃O₄. These vacancies could also act as sites for K⁺ intercalation.

FIG. 10C shows the Mn valance vs. the L₃:L₂ branching ratio defined as:

L₃:L₂ branching ratio=I(L₃)/(I(L₂)+I(L₃)) (3)

where I(L₃) and I(L₂) are the intensities of Mn(L₃) and Mn(L₂) edges from the EELS spectrum of each sample.

In order to compare the calculated valences vs. reference values (FIG. 10C), the EELS spectra of MnO, Mn₂O₃ and MnO₂ have been extracted from literature and the corresponding L₃:L₂ branching ratios have been used as reference points. This graph confirms that the Mn valance for the fresh catalyst is about 4, indicating the unreduced MnO₂. The Mn valance decreases to 3.1 after ten cycles (i.e., MnOOH and Mn₂O₃), whereas extensive cycling, up to one hundred cycles, lowers the Mn valance from 2.9 to 2.6 for the first and second Mn(L₃) edge, respectively (FIG. 10C). The latter values indicate the increased formation of Mn²⁺ species such as MnO and Mn(OH)₂ leading to hausmannite (Mn₃O₄) as the final composition. It has been reported that hausmannite, which is believed to appear at about 633 mV during MnO₂ reduction, shows poor electrocatalytic activity for both ORR and OER compared to MnO₂ alone. There is a debate whether hausmannite can be electrochemically oxidized or not. While some studies have claimed that Mn₃O₄ is electrochemically inactive and cannot be oxidized to Mn⁴⁺ oxide species, others have identified hausmannite as an outstanding choice for supercapacitor applications and also proposed that it could be transformed to layered birnessite structure (δ-MnO₂) after severe cycling. The present results in FIG. 10C show that MnO₂ is not regenerated efficiently during potential cycling between 633 to 1483 mV. However, in spite of profound MnO₂ structural changes during cycling, as shown by us previously, the electrodes activated by OCP exposure to K⁺ exhibited superior cycling durability. Furthermore, the activity of degraded electrodes can be regenerated by OCP K⁺ treatment. It was proposed that the potassium ions intercalated into the catalyst layer act as promoters for both ORR and OER by providing adsorption sites for intermediate species.

Oxide Catalyst Layer Activation by Potential Driven Intercalation (PDI) of K⁺

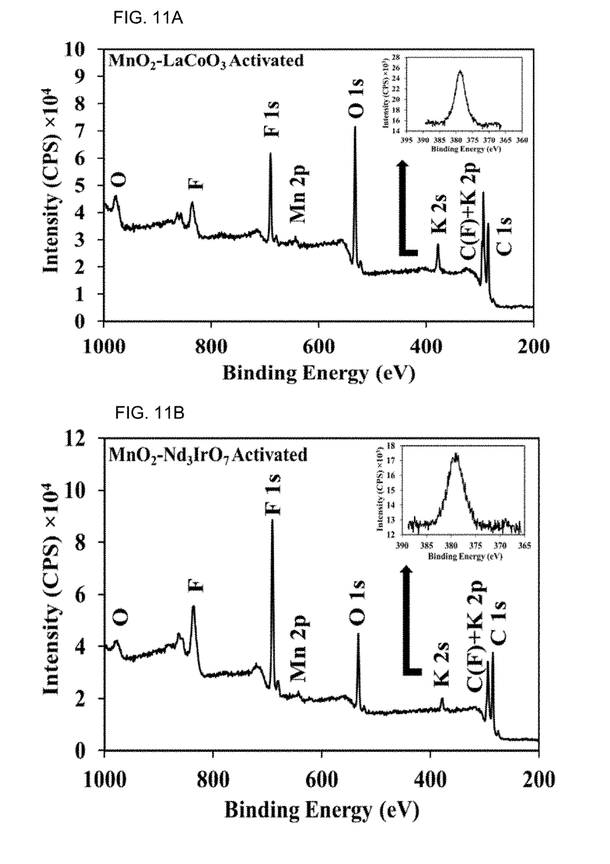

In order to accelerate the insertion of K⁺ into the oxide catalyst layer, an electrophoretic method was developed and investigated, referred to as potential driven intercalation (PDI). The presence of potassium in the PDI activated samples was confirmed by XPS analysis (FIGS. 11A and 11B). The XPS spectra of the electrodes activated by the PDI and OCP methods are very similar (compare FIGS. 11A and 11B with FIGS. 8A to 8D). In future studies, to reveal possible differences between the two activation methods, it would be of interest to determine the 3D distribution of potassium in the catalyst layers.

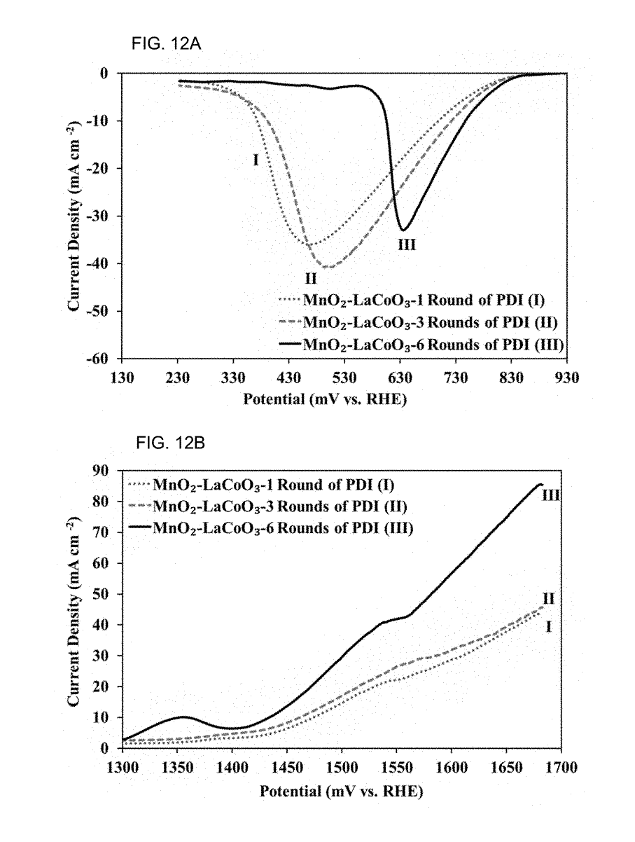

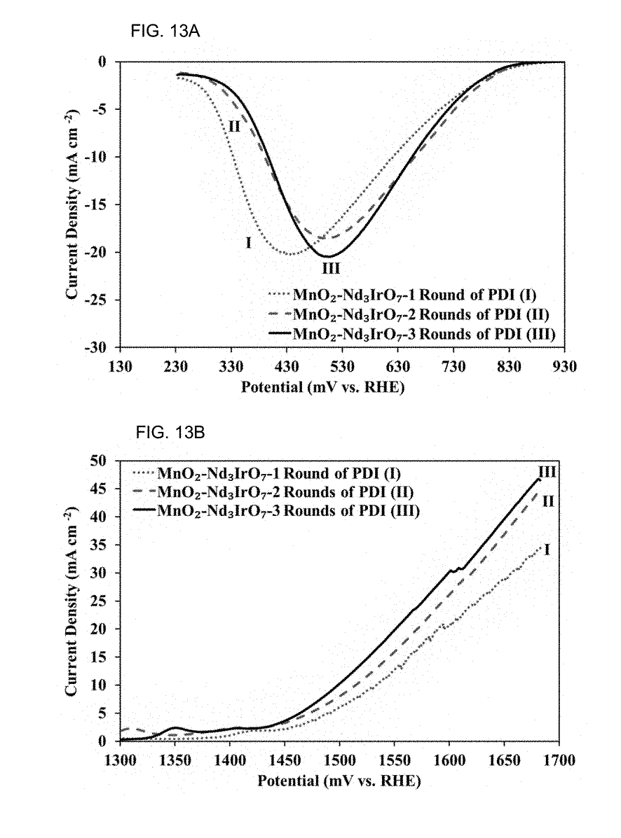

FIGS. 12A and 12B and FIGS. 13A and 13B show the electrocatalytic activity of MnO₂—LaCoO₃ and MnO₂—Nd₃IrO₇ catalysts after being activated using the PDI method for up to seven rounds, each activation round lasting 30 min.

First it is noted that in the ORR region, for both catalyst layers a peak current density is reached, controlled by dissolved O₂ mass transfer from the bulk solution to the reaction layer (FIGS. 12A and 13A). Next, in case of MnO₂—LaCoO₃ (FIG. 12A), repeating the PDI activation procedure shifted positively the ORR peak potential from 465 mV (1^{st} round) to 635 mV (6^{th} round). Further repetition of the PDI activation beyond six rounds did not produce any additional benefits for ORR catalysis. Furthermore, the PDI method (6^{th} round) increased about ten times the ORR current density at 730 mV compared to the unactivated case (FIGS. 7A and 12A).

In case of MnO₂—Nd₃IrO₇ (FIG. 13A), the shift of the ORR peak potential was more limited, from 430 mV (1^{st} round) to 500 mV (2^{nd} round and beyond). The ORR current density at 730 mV increased about two times after the PDI treatment (three rounds) compared to the unactivated case.

Regarding the OER section of the MnO₂—LaCoO₃ catalyzed polarization curve (FIG. 12B) and considering 1450 mV as an arbitrary reference potential, PDI activation (after 6th rounds) generated a current density of 14 mA cm⁻², open-circuit K⁺ activation produced 9.5 mA cm⁻² (FIG. 7B), whereas without any type of K⁺ activation the current density was only about 0.2 mA cm⁻² (FIG. 7B). Similar improvements were observed in the case of PDI activated MnO₂—Nd₃IrO₇ as well.

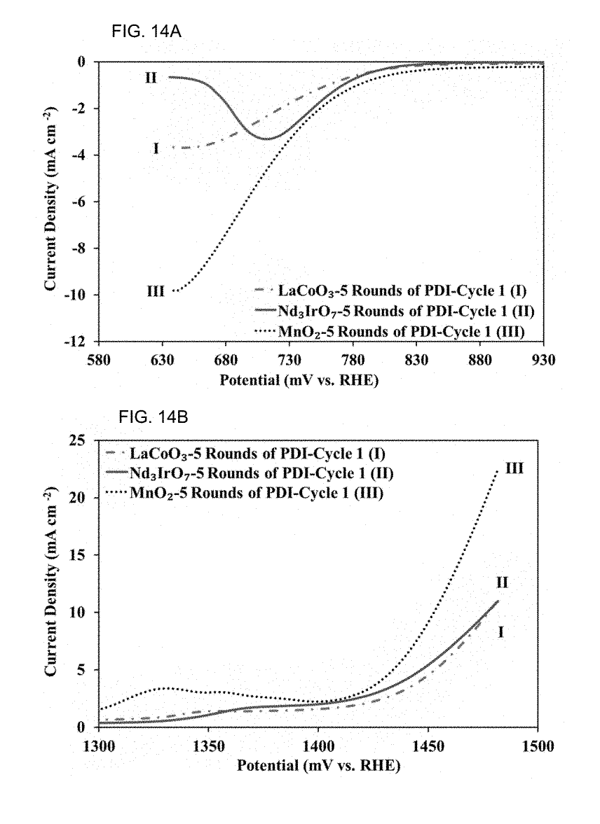

To better understand the role of potassium intercalation on the bifunctional performance of the mixed oxide catalysts, 5 rounds of PDI activation was also applied to each catalyst alone, i.e., MnO₂, LaCoO₃ and Nd₃IrO₇ (FIGS. 14A and 14B). While K⁺ activation enhances the ORR electrocatalytic activity of all individual oxides (compare FIGS. 5A and 14A), the method is most effective for MnO₂. The OER performance of the individual oxides are also improved by the PDI activation with MnO₂ surpassing both LaCoO₃ and Nd₃IrO₇ catalysts (FIG. 14B). XPS analysis revealed the presence of potassium in all three oxides after PDI activation (results not shown). The individual oxide polarization performance results presented by FIGS. 14A and 14B substantiate our hypothesis that the main mechanism for bifunctional activity enhancement is related to K⁺ intercalation into the vacancies or Schottky defects of MnO₂ surrounded by OH⁻ ions. Comparing the mixed and individual oxides activated by PDI (FIGS. 12A-B, 13A-B and 14A-B), it is clear that due to the synergy between either MnO₂ and LaCoO₃ or MnO₂ and Nd₃IrO₇, the mixed oxide catalysts possess superior bifunctional electrocatalytic activity than any of the oxides individually.

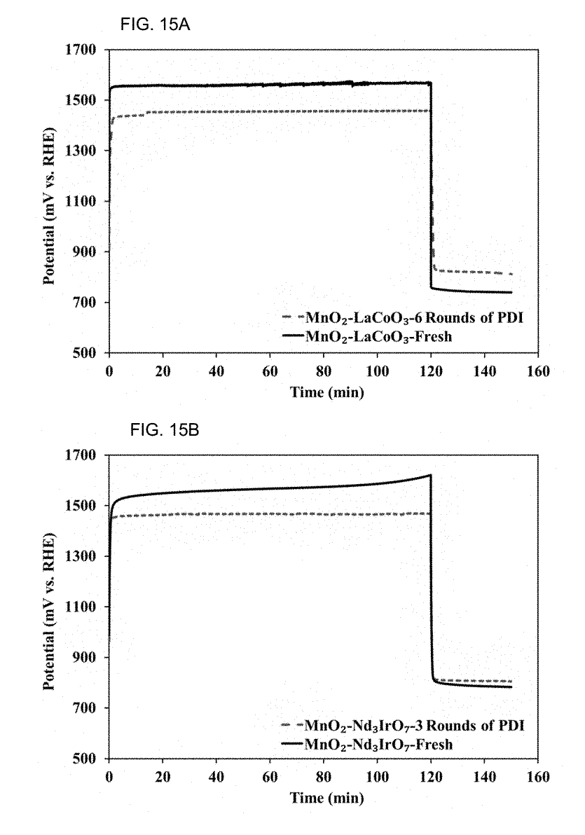

In addition to potential cycling experiments, galvanostatic polarization (i.e., chronopotentiometry) was also performed in order to assess the effect of PDI activation on electrocatalytic activity and stability. The oxide loading was the same as in all other experiments, namely, 0.5 mg cm⁻² for each of the oxides. For OER, a constant current density (per geometric area) of 5 mA cm⁻² (or 5 A g⁻¹ per total catalyst mass) was applied for 2 hrs, whereas for ORR, −2 mA cm⁻² (or 2 A g⁻¹ per total catalyst mass) was applied for 30 min (FIGS. 15A and 15B). The flooded electrode half-cell arrangement used in the present study imposes some limitations with respect to the current densities that can be applied during galvanostatic longer-term experiments. These conditions are different compared to the cell design that would be used in practice, for instance in a rechargeable zinc-air battery. Therefore, the experiments presented by FIGS. 15A and 15B provide only a preliminary insight into durability and further studies are required under conditions more relevant to the industrial practice.

The ORR current density was chosen to be sustainable by the availability of dissolved O₂ in the O₂ saturated 6M KOH electrolyte for a more extended period of time (e.g., 30 min). In practice, a gas diffusion oxygen electrode would be used either air breathing or exposed to a convective air (or oxygen) flow. The OER current density of 5 mA cm⁻² for 2 hrs, was selected to provide relevant longer-term electrocatalytic stability information, while avoiding the heavy O₂ gas evolution expected at high current densities that could shield and/or damage the electrode surface in the present configuration. Two hours galvanostatic polarization was also proposed as an OER benchmarking criteria by McCrory et al., albeit at a current density of 10 mA cm⁻² but for an unspecified catalyst loading. Hence, it is difficult to employ identical conditions to the latter study.

Comparing first the unactivated fresh catalysts, the OER behavior of MnO₂—LaCoO₃ was superior over the 2 hr testing period compared to MnO₂—Nd₃IrO₇ (FIGS. 15A and 15B). For the latter catalyst (FIG. 15B), the potential increased from 1480 mV (at t=1 min) to 1621 mV (at t=2 h), whereas in case of fresh MnO₂—LaCoO₃ the electrode potential was much more stable, i.e., 1549 mV (at t=1 min) and 1568 mV (at t=2 h). PDI activation had a positive influence on both catalysts by reducing the O₂ evolution potential by about 110 mV in case of MnO₂—LaCoO₃ (FIG. 15A) and up to 152 mV (at t=2 h) on MnO₂—Nd₃IrO₇ (FIG. 15B). Furthermore, the stability of the OER activity for the PDI activated MnO₂—Nd₃IrO₇ catalyst is markedly superior compared to the unactivated case. Thus, for MnO₂—Nd₃IrO₇ the rate of OER potential increase is lowered from 70.5 mV h⁻¹ (fresh unactivated catalyst) to 10 mV h⁻¹ (PDI activated).

Regarding the galvanostatic ORR response (at −2 mA cm⁻²), the electrode potential on fresh MnO₂—Nd₃IrO₇ was about 43 mV (at t=30 min) higher than on MnO₂—LaCoO₃. PDI activation increased the ORR electrode potential of the latter catalyst by about 75 mV (at t=30 min) (FIG. 11A), whereas it had a lesser influence on MnO₂—Nd₃IrO₇ (15 mV higher potential). These findings corroborate the cycling polarization experiments on the two catalyst formulations presented by FIGS. 12A-B and 13A-B. The rate of ORR potential degradation was also improved from −30 mV h⁻¹ to −24 mV h⁻¹ for MnO₂—LaCoO₃ and from −38 mV h⁻¹ to −14 mV h⁻¹ for MnO₂—Nd₃IrO₇.

Comparison of Bifunctional ORR/OER Activities: Present Work Vs. Literature

It is inherently difficult to compare catalysts from various literature sources because the apparent performance is dependent not only on the intrinsic electrocatalytic activity but also on other interacting factors such as the catalyst loading and dispersion, catalyst layer structure and composition (e.g., presence or absence of support and/or ionomer and/or PTFE) and electrode manufacturing conditions. In spite of the above-mentioned shortcomings, we believe a comparison with literature results is warranted to place in a broader context the results obtained here with respect to representative precious and non-precious metal catalysts reported in the literature.

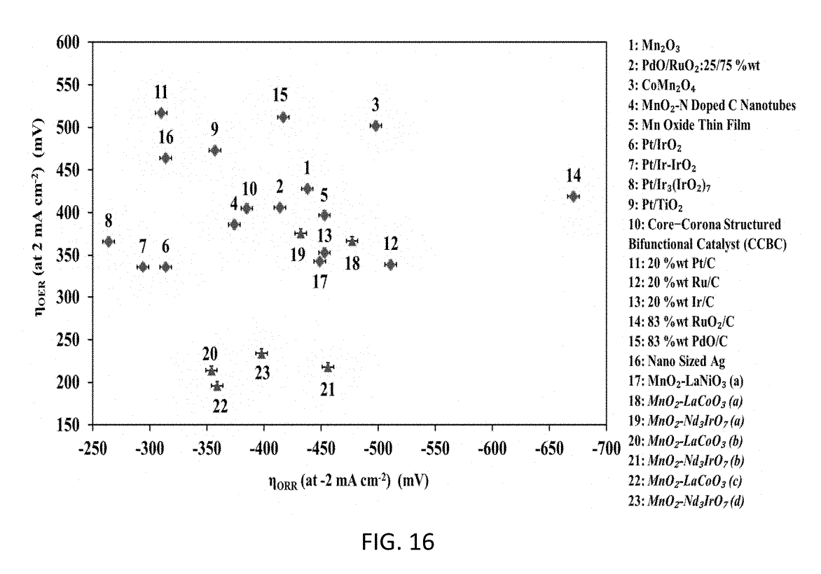

FIG. 16 presents a comprehensive comparison of the ORR and OER overpotentials (at −2 and 2 mA cm², respectively) for the mixed oxide catalysts MnO₂—LaCoO₃ and MnO₂—Nd₃IrO₇ investigated here, and relevant catalyst examples from literature. The overpotentials at 2 and −2 mA cm⁻² were chosen for comparison because of the available literature data in the latter current density range for diverse catalysts and catalyst loadings. Catalysts with the best and worst bifunctional activity are in the lower bottom-left and top-right corner of FIG. 16, respectively.

The K⁺ activated mixed oxide catalysts (MnO₂—LaCoO₃ and MnO₂—Nd₃IrO₇, with indices between 20 and 23, FIG. 16) are all situated in the lower half of the diagram due to their low OER overpotential at 2 mA cm⁻². The latter is between 100 to 150 mV lower than the reported OER overpotentials for catalysts such as: 20% wt Ir/C, 20% wt Ru/C, Pt/IrO₂, Pt/Ir—IrO₂ and Pt/Ir₃(IrO₂)₇. Compared to the unactived MnO₂—LaCoO₃ and MnO₂—Nd₃IrO₇ catalysts (indices 18 and 19), K⁺ activation lowered the OER overpotentials by up to 175 mV.

With respect to ORR, catalysts such as: nano sized Ag, 20% wt Pt/C, Pt/Ir—IrO₂ and Pt/Ir₃(IrO₂)₇ generated lower overpotentials than those reported in the present work. However, other non-precious metal catalysts such as nanostructured Mn oxide thin film and Core-Corona Structured Bifunctional Catalyst (CCBC) had significantly higher ORR overpotentials (FIG. 16).

Conclusion

The electrocatalytic activities for ORR and OER of mixed oxides composed of MnO₂ combined with either LaCoO₃ (perovskite) or Nd₃IrO₇ (fluorite-related orthorombic structure space group Cmcm), was studied. A positive synergistic electrode kinetic effect between the oxide components was found as shown by either a decrease of the apparent Tafel slope or increase of the apparent exchange current density for the mixed oxide formulation compared to the respective single oxides. At an OER current density of 10 mA cm⁻², the corresponding overpotentials on the mixed oxide catalysts were 440 and 501 mV on MnO₂—LaCoO₃ and MnO₂—Nd₃IrO₇, respectively. The latter overpotentials, representative for the initial stage catalytic activities, are significantly lower than on any of the individual oxides investigated. The mechanism for the mixed oxide synergistic electrocatalytic effect could be rationalized in terms of the scaling relationship between HOO* and HO* binding energies. The structurally diverse oxide combinations provide different binding energies for the key intermediates, thus, ‘breaking’ the linear scaling relationship.

In addition, the role of K⁺ insertion in the catalyst structure was investigated by two methods: longer-term exposure of the catalysts in 6 M KOH and potential driven (electrophoretic) intercalation, respectively. Both methods are effective for enhancing the bifunctional activity and durability of the mixed oxides catalysts. At constant current density of 5 mA cm⁻² (or 5 A g⁻¹ catalyst) applied for 2 hrs, the OER overpotential is lowered by 110 mV and 152 mV due to potential driven potassium ion insertion in MnO₂—LaCoO₃ and MnO₂—Nd₃IrO₇, respectively. Furthermore, the rate of OER potential increase, a measure of electrocatalytic activity degradation, is diminished by the application of the potential driven potassium intercalation from 70.5 mV h⁻¹ (fresh unactivated catalyst) to 10 mV h⁻¹.

In case of ORR as well, the potential driven intercalation of potassium was effective lowering the overpotential on MnO₂—LaCoO₃ by 75 mV at a constant current of −2 mA cm⁻² (or −2 A g⁻¹ catalyst). The rate of ORR potential degradation was also improved from −30 mV h⁻¹ to −24 mV h⁻¹ for MnO₂—LaCoO₃ and from −38 mV h⁻¹ to −14 mV h⁻¹ for MnO₂—Nd₃IrO₇. It is noted that all the experiments in the present study were performed with gas diffusion electrodes operated in flooded mode using dissolved O₂.

It is proposed that the reason for enhanced ORR/OER performance of the activated catalysts is the uptake of K⁺ into the catalyst layer (mostly in the vacancies and defects of the MnO₂ crystal structure) acting as a promoter for both ORR and OER. The K⁺ uptake was demonstrated by both XPS and EDX analysis.

In further summary, the bifunctional oxygen reduction and evolution reaction (ORR and OER, respectively) electrocatalytic activity and durability of mixed oxides MnO2-LaCoO3 and MnO2-Nd3IrO7, were investigated. The goal was to identify possible beneficial synergistic catalytic effects between the two oxides and to investigate the role of alkali ions (Li+, Na+, K+ and Cs+) for promotion of electrocatalytic activity and durability. The combination of the two, structurally different, oxides, improves the bifunctional activity compared to the individual oxide components, as shown by either lower apparent Tafel slopes or higher exchange current densities for ORR and OER in 6 M KOH. Insertion of potassium ion in the oxide structure either by longer-term exposure to 6 M KOH or by an accelerated potential driven intercalation method, lowers further both the OER and ORR overpotentials. At constant current density of 5 mA cm-2 (or 5 A g-1 catalyst) for two hours, the OER overpotential is lowered by 110 mV and 152 mV due to potential driven potassium ion insertion in MnO2-LaCoO3 and MnO2-Nd3IrO7, respectively. For ORR, at −2 mA cm-2 (or −2 A g-1 catalyst) the overpotential on MnO2-LaCoO3 is decreased by 75 mV. In addition, the stability of the potassium ion activated catalysts is also improved. The ORR activity promotion effect is specific to potassium compared to all other investigated alkali metal hydroxides (LiOH, NaOH, CsOH), whereas for OER, cesium ion has also a smaller beneficial effect. The electrode kinetic results are supported by surface analysis showing the presence of potassium in the catalyst.

### Surfactant-Assisted Electrodeposition of Manganese Oxides.

One of the greatest challenges of the 21^{st} century lies in meeting the global energy demand in a sustainable way. The intermittent and unpredictable nature of the green energy sources has severely hindered the deployment of these energy generation methods. Development of reliable and efficient energy storage systems is crucial in promoting renewable energy sources. The metal-air systems are regarded as attractive form of energy conversion and storage devices due to high theoretical energy density, long shelf-life, cost-effectiveness, environmental benignity and safe operation due to absence of H₂. Oxygen electrochemistry involving conversion between oxygen and water is necessary in the development of the metal-air battery and regenerative fuel cell technology. The intrinsic sluggish kinetics of oxygen reduction reaction, large overpotentials associated with oxygen reduction and evolution reactions (ORR and OER) at the cathode, however, greatly suppress the practical energy density, highlighting the importance of developing novel bifunctional electrocatalysts with high electrocatalytic activities towards both ORR and OER to grasp the full potential of the regenerative fuel cells and metal-air batteries as beneficial energy conversion and storage devices.

Manganese oxides are an attractive catalyst material due to cost-competitiveness, environmentally friendliness, natural abundance, good stability against corrosion and excellent reactivity for ORR and to some extent for OER. The physicochemical and electrochemical properties of MnOₓ are highly dependent on its morphology and crystallographic nature. The γ-MnO₂, an intergrowth of pyrolusite (β-MnO₂) in the ramsdellite (α-MnO₂) matrix, is known as one of the most electrocatalytically active crystal structures of manganese oxides for ORR in alkaline media with modest ORR Tafel slope of 40 mV dec⁻¹ and exceptionally low ORR overpotential of −375 mV (at −2 mA cm⁻²). When it comes to morphology, nanostructured MnO generally outperforms the bulk particles due to higher specific surface area, meaning more active sites available to facilitate the O₂ reduction/oxidation reactions, as well as higher porosity, meaning more room for oxygen bubbles to evolve. Studies showed promising ORR and OER electrocatalytic activities for electrochemically deposited nanostructured manganese oxides, i.e. ORR and OER overpotential of −311 mV (at −2 mA cm⁻²) and 405 mV (at 2 mA cm⁻²).

Different synthesis methods of nano-sized MnOₓ are possible including hydrothermal synthesis, sol-gel synthesis, thermal decomposition, chemical co-precipitation and electrodeposition methods. The use of the latter technique is especially attractive due to several merits including ease of processing, low production cost, environmental compatibility, better control over properties of deposited material, high degree of reproducibility and high yield of nanostructured manganese oxide with different morphologies and crystallographic phases. Anodic electrodeposition of MnO₂ is attractive mainly due to its flexibility at scale and control on the morphology as well as crystallographic phases of the final deposited MnOₓ. Anodic electrochemical deposition of MnO₂ involves oxidation of Mn²⁺ species on the anode while hydrogen evolution is happening on the cathode in an aqueous media of manganese salt using a wide range of electrochemical techniques including galvanostatic, potentiostatic, potentiodynamic and pulse deposition method, as described by eq. 4:

Mn²⁺+2H₂O→MnO₂+4H⁺+2e⁻ (4)

Mn concentration is a factor that can affect morphology, crystal structure and the mechanism by which manganese oxide deposits on the substrate during anodic electrodeposition. Applied anodic potential can also alter the crystallinity, surface morphology and coverage, pore density and more importantly, Mn valance of the electrodeposited Mn oxide. Temperature is another factor that can play a role on the nucleation and growth rates as well as morphology of the electrodeposited manganese oxides. The change in each of these factors leading to different crystal structures, morphologies, pore densities and Mn valances can alter electrocatalytic activity of the electrodeposited manganese oxide for both ORR and OER.

Surfactants are active surface agents that can significantly change the surface coverage and morphology of electrodeposited materials by mainly adsorbing to the solid/liquid interface, acting as a deposition template, reducing the interfacial energy and controlling the nucleation and growth of the particles, resulting in distinctive electrochemical activities for the deposited particles. Surfactant-assisted electrodeposition may be used with manganese oxides to obtain nanostructured materials with different morphologies for wide range of applications such as batteries and electrochemical capacitors. It is possible to study the individual effect of these electrodeposition factors, i.e. Mn²⁺ concentration, applied potential, temperature and surfactant on the morphology, and the electrochemical properties of electrodeposited manganese oxides. Additionally, an important aspect for consideration is the complex interactions between all of the electrodeposition operating parameters. These complicated interactions are relevant to more reliable predictions of the response each parameter has on electrochemical properties of the electrodeposited manganese oxides in presence of other variable factors.

An aim of this work is to provide a systematic study on finding an active nanostructured manganese oxide for both ORR and OER produced via anodic electrodeposition. A comprehensive study is performed to investigate the main effects and important interaction effects of key operating parameters that influence the electrosynthesis of manganese oxides, i.e. Mn²⁺ concentration, applied potential, temperature, surfactant type and concentration, on the catalyst response using a two-level half-fraction factorial design. Sodium dodecyl sulfate (SDS) as anioinc, hexadecyl-trimethyl-ammonium bromide (CTAB) as cataionic and Triton X-100 as non-ionic surfactants are employed in this study to electro-synthesize the nanostructured MnO while several surface characterization methods has been used to analyze morphology and Mn valance of the synthesized catalysts.

### Experimental Methods

Anodic Electrodeposition of Manganese Oxide

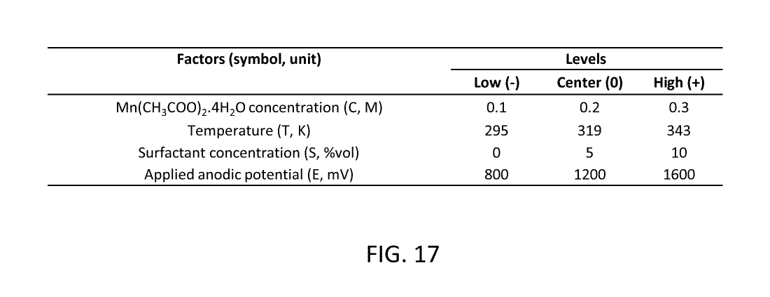

Manganese oxides were electrodeposited onto a 6 mm diameter of 40% wt PTFE treated carbon cloth substrate from Fuel Cell Earth under various manganese (II) ion concentrations, temperatures, surfactant concentrations and applied potentials, as outlined in FIG. 17. Three different types of surfactants were used, i.e. Sodium dodecyl sulfate (SDS) as anioinc, hexadecyl-trimethyl-ammonium bromide (CTAB) as cataionic and Triton X-100 as non-ionic surfactants. The electrolyte solution used was a mixture of various concentrations of manganese (II) acetate tetrahydrate (Mn(CH₃COO)₂.4H₂O) and 0.1 M sodium sulphate solution (Na₂SO₄). A half-fraction 2″ factorial design was constructed using the statistical software JMP 11. For a half-fraction factorial design of four factors (FIG. 17) with three center points, the number of experimental runs required for each surfactant type was 11, compiling to a total of 33 random runs for the entire screening design experiments.

Prior to the electrodeposition, the carbon substrate was pretreated using nitric acid treatment to reduce the hydrophobicity of the carbon cloth and remove any impurity as well as surface oxides on the carbon fiber surfaces. 40% wt PTFE treated carbon cloth was dipped in acetone for 5 min and washed thoroughly with DI water. The substrate was then soaked in 1 M nitric acid at 333 K for 30 min. The samples were washed thoroughly with DI water and left to dry overnight at 343 K in an oven.

A conventional three-electrode electrochemical half-cell setup was used for the electrodeposition process. The working electrode was a punch-cut circular 40 wt % PTFE treated carbon cloth with geometric surface area of 0.283 cm² in a quick-fit exchangeable sample holder from Radiometer Analytical (#A35T450) attached to a rotating disk electrode (RDE) setup. The reference and counter electrodes were Hg/HgO/20% wt KOH (MOE) and platinized titanium plate, respectively. The electrodes were connected to a computer-controlled VoltaLab 80 potentiostat in its associated RDE setup. The anodic electrodeposition was performed under different conditions as outlined in FIG. 17 using potentiostatic method at rotation speed of 400 rpm for 30 minutes per each run. After the completion of electrodeposition process, the working electrode was washed thoroughly with DI water. In the case where surfactant was used, the surfactant residue was removed by dipping the sample in isopropyl alcohol (IPA) at 343 K for 15 minutes at 400 rpm. The catalyst-coated carbon cloth was then rinsed with DI water again.

Electrochemical Measurements of Electrocatalytic Activities

The bifunctional electrocatalytic activity of the samples for both ORR and OER was tested in a half-cell RDE setup with the electrodeposited MnOₓ on carbon cloth fitted in the RDE tip as the working electrode, Hg/HgO/20% wt KOH (abbreviated as MOE) as the reference electrode and platinum mesh as the counter electrode while connected to Voltalab 80 potentiostat. Cyclic voltammetry tests were performed in O₂ saturated 6 M KOH at 293 K in the potential range of −700 to 750 mV_{MOE} with a scan rate of 5 mV s⁻¹ at 400 rpm. Always the potential scan was started from −700 mV_{MOE} going in the direction of anodic polarization. Each sample was activated up to five cycles prior to running the performance tests by potential scanning between −700 and 750 mV_{MOE} at 5 mV s⁻¹, 400 rpm and 293 K, starting with anodic polarization. Galvanostatic polarization tests were started with applying a constant current density (per geometric area) of 5 mA cm⁻² for 2 hrs followed by −2 mA cm⁻² for 30 min. The current densities were chosen to avoid mass transport limitations in the flooded electrode half-cell arrangement used in the present study during galvanostatic longer-term experiments. All of the cyclic voltammograms and galvanostatic polarizations are IR-corrected using “Static Manual” ohmic drop compensation feature of VoltaLab 80 potentiostat. The potential of Hg/HgO/20% wt KOH reference electrode was 955.8 mV vs. RHE in 6 M KOH at 293 K, measured using the reversible hydrogen reference electrode (HydroFlex) from Gaskatel GmbH. The equilibrium oxygen electrode potential in 6 M KOH was calculated to be 1174 mV_{RHE} or 218.2 mV_{MOE}.

Surface Characterization of Electrodeposited Catalysts

The morphology and surface elemental composition of the electrodeposited catalysts were fully characterized by Field Emission Scanning Electron Microscopy (FESEM, Hitachi S-4700) and X-ray Photoelectron Spectroscopy (XPS, Leybold Max 200 and Kratos AXIS Ultra), respectively. The XPS source was monochromatic Al Kₐ. The manganese oxidation state was determined from the multiplet splitting of Mn 3s and the corresponding separation of peak energies at the XPS spectrum of the samples.

Fourier Transfer-Infrared Spectroscopy (FT-IR) with attenuated total reflectance (ATR) (PerkinElmer Frontier FT-IR) was used to confirm the efficiency of the surfactant removal technique on the catalyst coated carbon clothes.

Results and Discussion

Anodic Electrodeposition Behavior with and without Surfactants

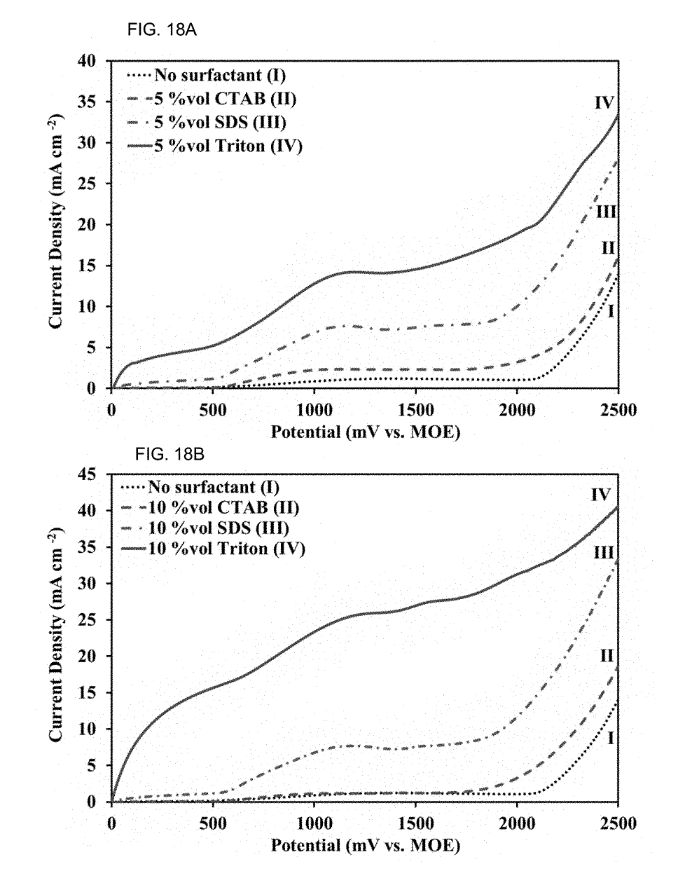

Linear sweep voltammetry (LSV) tests have been used to investigate the anodic electrodeposition behavior of manganese oxides on carbon cloth in presence of different types and concentrations of surfactants as well as identifying suitable potential range for MnO electrodeposition while avoiding OER (FIGS. 18A and 18B). As shown in FIGS. 18A and 18B, the anodic peak corresponding to the electrodeposition of MnOₓ on the carbon cloth with no surfactant available starts at around 450 mV_{MOE}, reaches its max. current density of 1.2 mA cm⁻² at 1365 mV_{MOE} and is then joined by the OER at around 2000 mV_{MOE}. The addition of surfactants, i.e. CTAB, SDS and Triton, with different concentrations, i.e. 5 and 10% vol, to the 0.2 M Mn(CH₃COO)₂ and 0.1 M Na₂SO₄ solution seems to shift the anodic peak of MnO electrodeposition along with the OER onset potential to more negative potentials (FIGS. 18A and 18B). While Mn²⁺ oxidation peak stays between 1000 to 1200 mV_{MOE} for all types of surfactants at the concentration levels studied here (FIGS. 18A and 18B), the OER onset potential, determined at the first increase in the current density after Mn²⁺ oxidation peak, reaches its minimum at around 1350 mV_{MOE} for the solution with 5 vol % of Triton X-100 (FIG. 18A). It is believed that surfactants can affect the OER by enhancing the H₂O₂ production which acts as a precursor of O₂ during water electrolysis on carbon electrodes. In order to avoid the OER, the potential range was fixed to 800 to 1200 mV_{MOE} with a center-point at 1000 mV_{MOE} for all conditions.

The mechanism behind the electrodeposition of manganese oxides was first introduced by Fleischmann et al. and further developed by Catwright and Paul as follow in low acidic and neutral media:

Mn_{bulk}²⁺→Mn_{ads}²⁺ (rds) (5)

Mn_{ads}²⁺→Mn³⁺+e⁻ (fast) (6)

Mn³⁺+2H₂O→MnOOH+3H⁺ (7)

MnOOH→MnO₂+H⁺+e⁻ (slow) (8)

The electrodeposition begins with the adsorption of Mn²⁺ ions on the surface of electrode as outlined in eq. 6, called the rate determining step (rds). This first reaction is the initial step in the electrodepostion of MnO₂ regardless of the pH of solution. Mn²⁺ ions are then oxidized to Mn³⁺ followed by hydrolyzation step leading to MnOOH (eqs. 6 & 7). The resulting manganese oxy-hydroxide can slowly be oxidized to MnO₂ in neutral and low acidic media via eq. 8 since Mn³⁺ ions are not stable in these solutions. The decrease in the anodic current density of Mn²⁺ oxidation peak has been attributed to the formation of insulating MnOOH layer (eq. 7) (FIGS. 18A and 18B).

Characterization of the Electrodeposited Samples

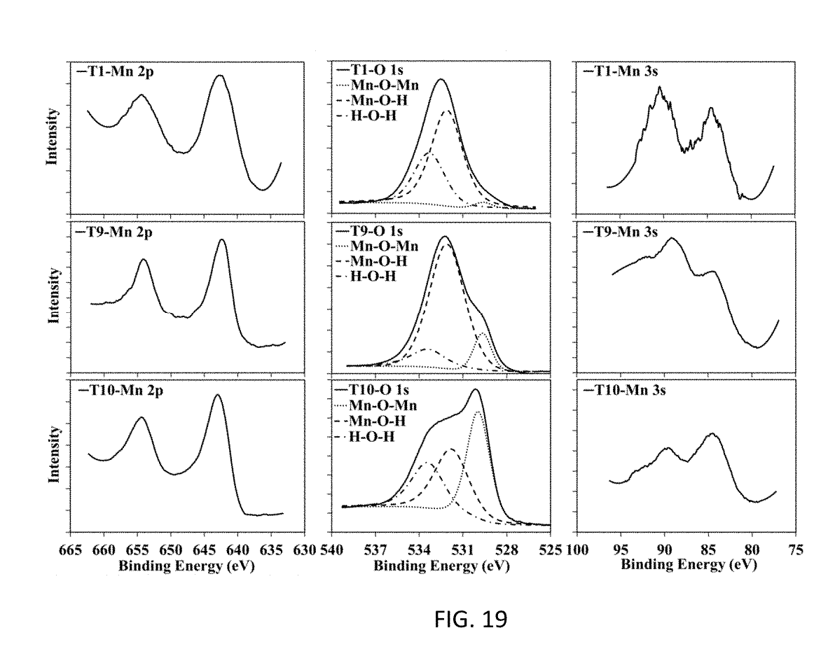

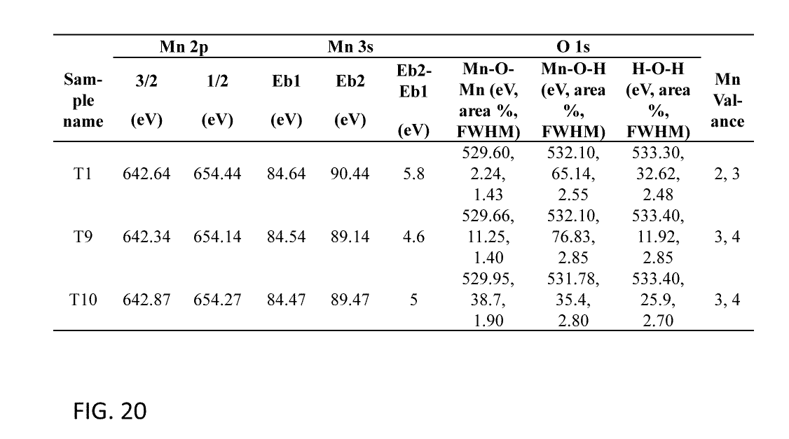

XPS spectra were used to identify the Mn valance of electrodeposited manganese oxides. Three representative XPS spectra for T1, T9 and T10 are shown in FIG. 19. The electrodeposition factors for each sample are as follow: T1 (C: 0.3 M, T: 295 K, S: Triton, 10% vol, E: 800 mV_{MOE}), T9 (C: 0.1 M, T: 343 K, S: Triton, 10% vol, E: 800 mV_{MOE}), T10 (C: 0.3 M, T: 295 K, S: Triton, 0% vol, E: 1600 mV_{MOE}). FIG. 20 summarizes the deconvoluted data for Mn 2p, O 1s and Mn 3s regions of these samples. The determination of Mn valance based on the location of Mn 2p peaks is usually associated with high uncertainties mainly due to the differential charging imposed by ejection of photoelectrons from inadequate conductivity of the material's surface leading to broadening or shifting of peaks. However, a combined analysis of Mn 3s doublet peak splitting and O 1s constituents can provide a meaningful understanding of Mn valance in the manganese oxides. The Mn 3s peak separation is caused by the electron exchange interaction in the 3s-3d level of Mn upon photoelectron ejection. Several Mn 3s doublet peak separation values have been reported in the literature including 4.5, 5.2, 5.4 and 5.8 for MnO₂ (Mn⁴⁺), Mn₂O₃ (Mn³⁺), Mn₃O₄ (Mn^{2+,3+}) and MnO (Mn²⁺), respectively. As shown in FIG. 19 and FIG. 20, the Mn 3s doublet peak separation values are consistent with the literature showing Mn valance of 2, 4 and mixture of 3 and 4 for T1, T9 and T10 samples, respectively. Further, O 1s can be deconvoluted to three oxygen containing chemical bonds including Mn—O—Mn (oxide), Mn—O—H (hydroxide) and H—O—H (water molecule). Relatively high content of hydroxide oxygen was detected on the surface of T1 and T9 samples, suggesting the co-existence of Mn³⁺ species with Mn²⁺ and Mn⁴⁺ for T1 and T9, respectively (FIG. 19 and FIG. 20).

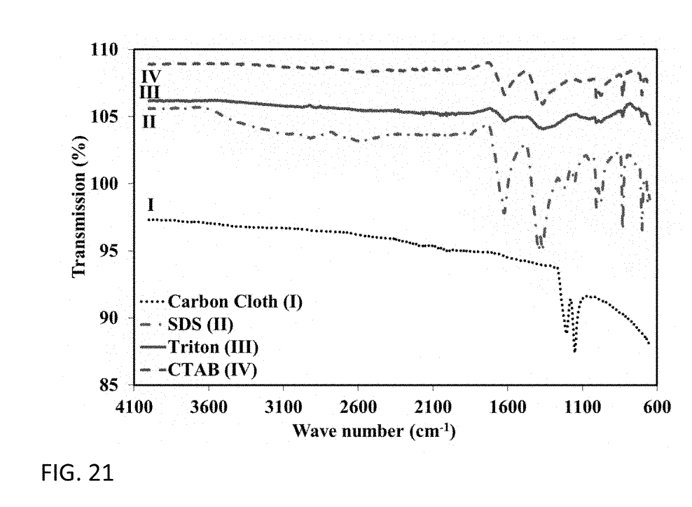

Several methods have been reported for surfactant removal from the electrodeposited samples including heat treatment, UV/ozone treatment and acetone/IPA washing methods. IPA washing for 15 min at 343 K and 400 rpm rotation was chosen as a fast effective method without losing active material and damaging the crystal structure of electrodeposited MnOₓ. FTIR analysis was utilized to examine the effectiveness of IPA washing method for surfactant removal from the manganese oxides electrodeposited in solutions with highest surfactant concentration, i.e. 10% vol. FIG. 21 shows FTIR spectra for the electrodeposited MnOₓ samples under various electrodeposition conditions. The black dotted line (I), which represents FTIR spectrum of 40% wt PTFE treated carbon cloth after nitric acid treatment, shows two characteristic peaks between 1100-1200 cm⁻¹ that disappear after the completion of electrodeposition process, confirming successful deposition of materials on the substrate in all cases (FIG. 21). In the case of electrodeposited MnOₓ in SDS containing solution, two major peaks for SDS at 1200 and 1460 cm⁻¹ overlaps with peaks associated with MnO₂ stretching and O—H bending vibrations of water, respectively. Similar interferences happen for both CTAB and Triton samples where same peaks overlap with major peaks for CTAB at 1486 cm⁻¹ and Triton X-100 at 1113 and 1512 cm⁻¹. This makes it impossible to employ those peaks for evaluating the success of surfactant removal procedure. Since all of the surfactants used in this study contain a hydrocarbon chain composed of C and H, e.g. SDS (NaC₁₂H₂₅SO₄), CTAB (C₁₉H₄₂BrN) and Triton X-100 (C₁₄H₂₂O(C₂H₄O)ₙ(ₙ₌₉₋₁₀), traces of each surfactant on the electrodeposited MnOₓ can be detected using C—H stretching and C—H deformation vibrations of these hydrocarbon chains between 2700 to 3100 cm⁻¹ and at approximately 1490 cm⁻¹, respectively. As shown in FIG. 21, the absence of such major peaks between 2700 and 3100 cm⁻¹ for all of the samples indicates the efficiency of IPA washing method as a fast effective surfactant removal technique for the cases studied here.

Factorial Design Experiments

A 2ⁿ half-fraction factorial design of four factors (FIG. 17) with three center points (2⁴⁻¹+3) was constructed for each surfactant type, i.e. anioinic, cataionic and non-ionic, using JMP 11 statistical software compiling to a total of 33 random runs for the entire screening design experiments. With the defining relation of I=CTSE in 2⁴⁻¹ design, no main effect is aliased with any other main effect or any two-factor interaction. However, two-factor interactions are aliased with each other. The four main factors plus the three two-factor interaction alias pairs account for the seven degrees of freedom for the design. Pareto plots with estimates of factors and aliases were used to find the most important two-factor interaction in each alias pair based on the Ockham's razor scientific principle. An unreplicated factorial design is used to minimize the number of experimental runs. The single replicate strategy is a very common approach in variable screening experiments due to large number of factors under consideration. In order to remedy for the random error, a wide range of factor levels and three center points were introduced for each set of the experiments. Three different responses were introduced to better assess the ORR/OER bifunctional performances of the surfactant-assisted electrodeposited catalysts: 1) ORR mass activity at −300 mV_{MOE}, 2) OER mass activity at 600 mV_{MOE} and 3) ORR/OER potential window (the absolute difference between the ORR onset potential at −2 mA cm⁻² and OER onset potential at 2 mA cm⁻²). The catalyst loading was calculated using Fraday's law via integration of the chronoamperometry graphs assuming the current efficiency for the main MnO₂ anodic electrodeposition reaction is 100%. Since the catalyst loadings were different due to various factors involved for each run (FIG. 17), the mass activity values, defined as the ORR or OER current densities at −300 and 600 mV_{MOE}, respectively, divided by calculated loadings, were also employed as responses for the factorial design. The standard error for the mean value of each response calculated based on the three center-point tests has been assumed to be the max. error involved in all of the measurements.

Triton X-100 Surfactant-Assisted Electrodeposition

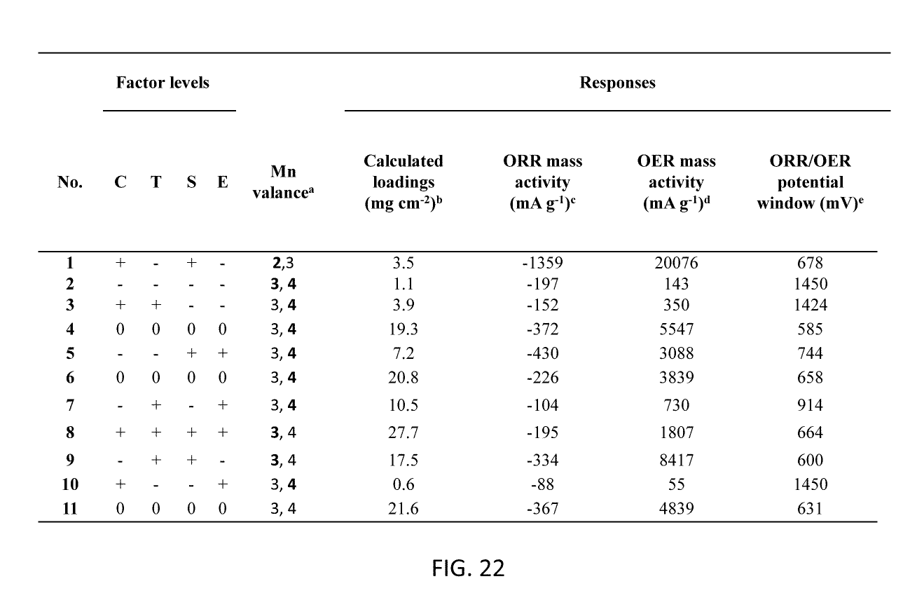

FIG. 22 shows the design matrix as well as responses for factorial runs in presence of Triton X-100 in a random order. Highest ORR and OER mass activities of −1359±202 and 20076±2098 mA g⁻¹, respectively, are obtained at high Mn concentration, low temperature, high surfactant concentration and low applied potential, i.e. run no. 1 (FIG. 22). However, the lowest ORR/OER potential window of 600±20 mV is achieved under opposite conditions of low Mn concentration and high temperature for run no. 9 (FIG. 22). It is worth mentioning that the MnOₓ electrodeposited at run no. 9 possesses the second best ORR and OER mass activity of −334±50 and 8417±879 mA g⁻¹, respectively.

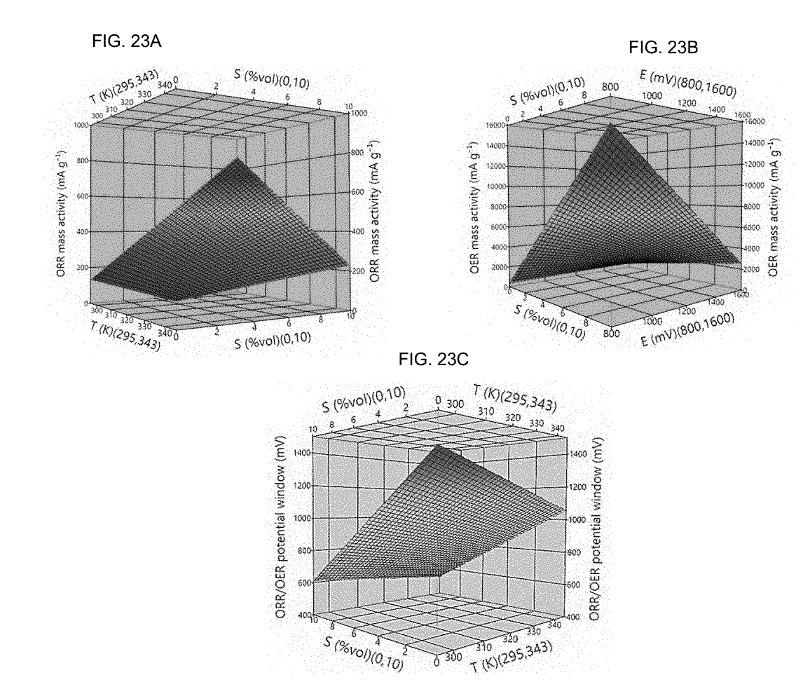

FIGS. 23A to 23C shows the surface plots of three different responses studied here for the electrodeposited manganese oxides in presence of Triton X-100, correlating them to the most important factors and two-factor interactions based on the Pareto plots of estimates. The Pareto plot analysis of the estimates for factors has shown that the Mn concentration effect on the performance of electrodeposited MnOₓ is not significant (results not shown here). The highest ORR mass activity can be achieved at high surfactant concentration and low temperature (FIG. 23A). Moreover, low applied anodic potential is found to further improve the ORR mass activity of the electrodeposited samples. Same trend is observed for the highest OER mass activity since it appears at high surfactant concentration, low temperature and low applied anodic potential (FIG. 23B). The lowest ORR/OER potential window can be obtained at high surfactant concentration, low applied anodic potential but high temperature (FIG. 23C). The temperature seems to be a defining factor for the optimum bifunctional characteristics of electrodeposited manganese oxides with high temperatures providing low ORR/OER potential window while low temperatures lead to high ORR/OER mass activities (FIGS. 23A to 23C). Other than the effect of temperature, high surfactant concentration together with low applied anodic potential bring best bifunctional performances for the electrodeposited oxides.

SDS Surfactant-Assisted Electrodeposition

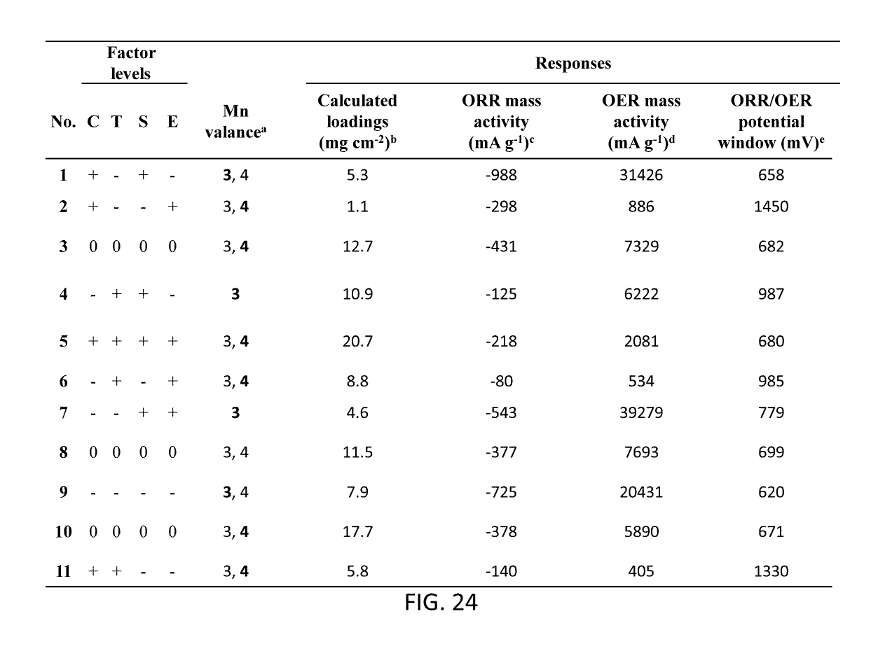

In the presence of SDS, −988±45 and 31426±2481 mA g⁻¹ are obtained as highest ORR and OER mass activities, respectively, for run no. 1 at high Mn concentration, low temperature, high surfactant concentration and low applied anodic potential (FIG. 24). While the lowest ORR/OER potential window of 620±7 mV is achieved for run no. 9 at same conditions but low Mn concentration and low surfactant concentration (i.e. 0%), run no. 1 seems to be a better choice considering its high ORR and OER mass activities as well as second-low ORR/OER potential window, i.e. 658±8 mV (FIG. 24).

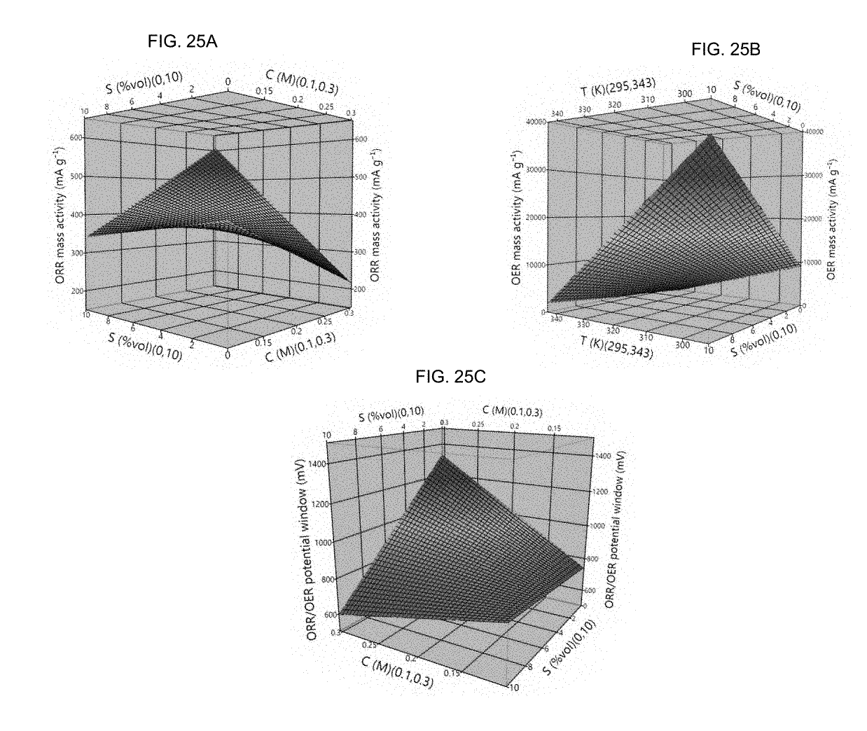

FIGS. 25A to 25C show the surface plots representing the relationship between the most important two-factor interactions with different responses for the electrodeposited manganese oxides in presence of SDS as surfactant. The Pareto plot analysis of estimates for factors revealed that the applied anodic potential is the least significant factor contributing to each of the responses for electrodeposited MnOₓ in this case (results not shown here). LSV graphs in presence of SDS shown in FIGS. 18A and 18B further confirm the insignificancy of applied anodic potential in the investigated regime, i.e. 800 to 1600 mV_{MOE}, since they all contribute about the same current densities for electrodeposition of manganese oxides on nitric acid pre-treated 40% PTFE treated carbon cloth. As shown in FIG. 25A, the highest ORR mass activity of about 600 mA g⁻¹ can be achieved at high surfactant concentration, high Mn concentration. Moreover, low temperature enhances the ORR mass activity of the electrodeposited MnOₓ OER mass activity of about 35000 mA g⁻¹ can be obtained at similar conditions of high surfactant concentration and low temperature but low Mn concentration (FIG. 25B). The lowest ORR/OER potential window of about 600 mV is believed to achieve at high surfactant concentration, high Mn concentration and low temperature (FIG. 25C). One can conclude that the optimum bifunctional responses of electrodeposited manganese oxides are sensitive to the Mn concentration with high Mn concentration leading to highest ORR mass activity and lowest ORR/OER potential window while low Mn concentration provides samples with highest OER mass activity. Overall, high surfactant concentration and low temperature lead to electrodeposited manganese oxides with preferable bifunctional properties.

CTAB Surfactant-Assisted Electrodeposition

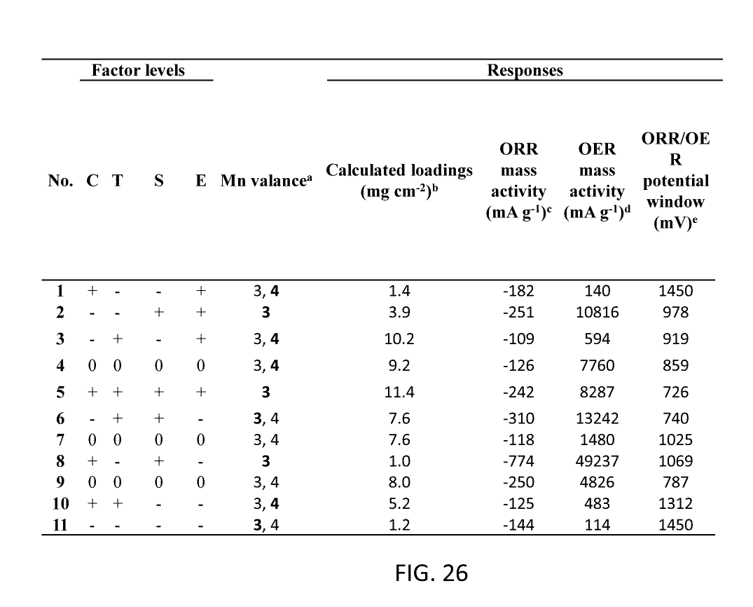

As shown in FIG. 26, CTAB-assisted electrodeposition of MnOₓ for run no. 8 generates −774±32 and 49237±2220 mA g⁻¹ as highest ORR and OER mass activities, respectively, at high Mn concentration, low temperature, high surfactant concentration and low applied anodic potential. However, the lowest ORR/OER potential window of about 730 mV is obtained for run no. 5 and 6 at high surfactant concentration but different other electrodeposition factors such as high temperature (FIG. 26). Overall, run no. 6 provides the best compromise between the two types of responses for the bifunctional electrocatalytic activity of the electrodeposited MnOₓ with the second best ORR/OER mass activities and ORR/OER potential window among the other runs (FIG. 26).

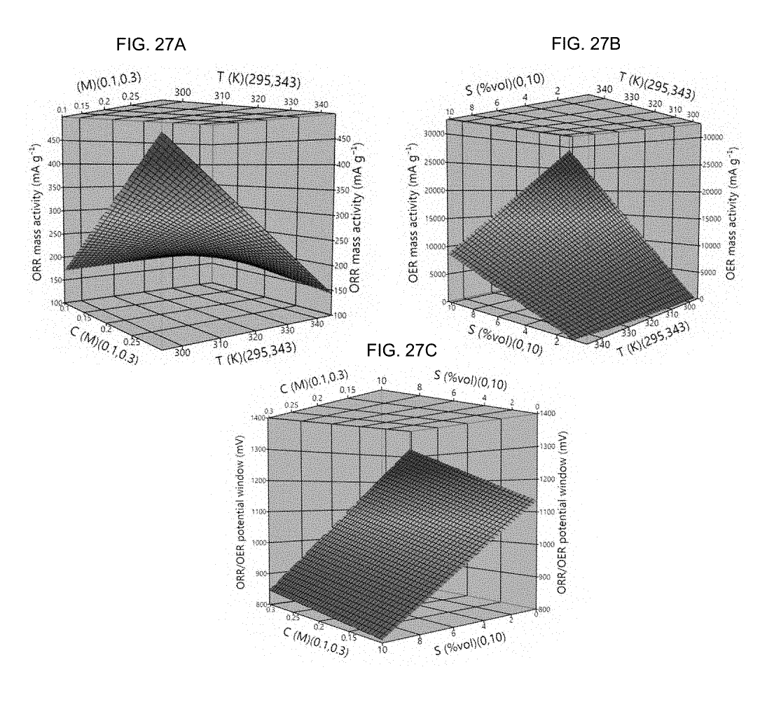

FIGS. 27A to 27C represent surface plots depicting effect of most important two-factor interactions on the three responses during CTAB-assisted electrodeposition of MnOₓ. The estimate analysis of factors using Pareto plots revealed that applied anodic potential in the investigated range has lesser effect on the responses comparing to the other three electrodeposition factors in presence of CTAB (results not shown here). In presence of CTAB, LSV graphs have also shown almost a constant current density through the whole potential range investigated here, i.e. 800 to 1600 mV_{MOE}, confirming that the applied anodic potential is not a major factor affecting the sample responses during surfactant-assisted electrodeposition of MnOₓ (FIGS. 18A and 18B). According to factorial design analysis showcased as surface plots in FIGS. 27A to 27C, the highest ORR mass activity of about 450 mA g⁻¹ can be obtained at high Mn concentration and low temperature (FIG. 27A). High surfactant concentration can further enhance the ORR mass activity of the electrodeposited MnOₓ (surface plots not shown here). The highest OER mass activity of almost 30000 mA g⁻¹ is achieved at similar conditions of high surfactant concentration, low temperature and high Mn concentration (FIG. 27B). When it comes to the ORR/OER potential window, values as low as 800 mV can be reached at high surfactant concentration but low Mn concentration and high temperature, unlike the mass activity cases (FIG. 27C). The optimum level of electrodeposition factors for the best ORR/OER bifunctional performance of MnOₓ samples depends on the definition of each response. While the ORR/OER potential window reflects on the catalyst performance at low current densities neglecting the effect of loading, ORR and OER mass activities provide better insight on the high current density responses of electrodeposited MnOₓ, normalized based on the catalyst loading. Both responses are valuable as the former reflects on more practical version of the ORR/OER catalyst performance covering the implications of mass transport issues due to the loading differences whereas the latter looks at the intrinsic bifunctional activity of the electrodeposited MnOₓ with different morphologies and crystal structures.

ORR/OER Performance Comparison

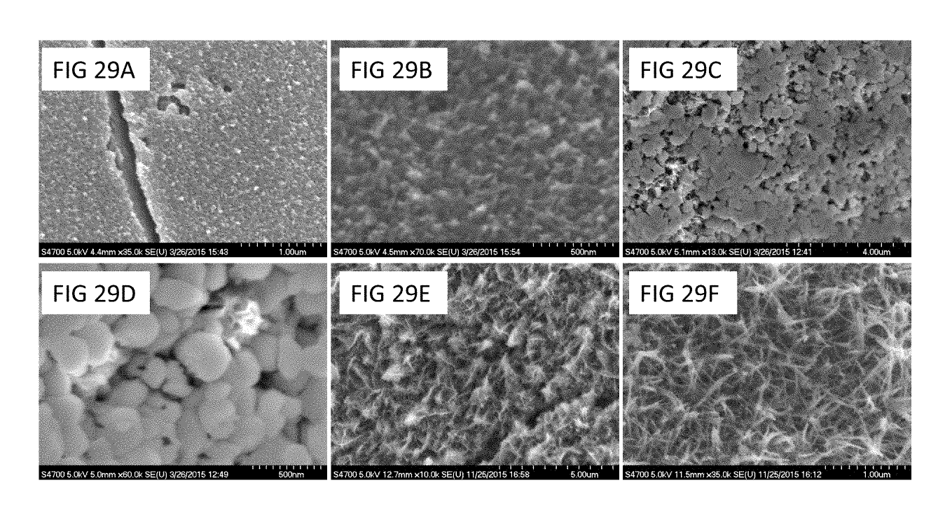

There are two mechanisms for the ORR on MnOₓ/C in alkaline media including direct and indirect 4-electron pathways. The latter mechanism includes a 2-electron reduction of O₂ on carbon sites yielding hydrogen peroxide ions (HO₂⁻) followed by either a 2-electron reduction of HO₂⁻ ions or a disproportionation reaction of HO₂⁻ to O₂ and OFF at manganese oxide sites, resulting in an overall 4-electron pathway. This mechanism is negligible in this case since the electrodeposited catalyst is not supported by any form of carbon material other than the substrate which, according to the SEM images of the samples, is believed to be fully covered by the electrodeposited MnOₓ (FIGS. 29A to 29F). The direct 4-electron pathway for ORR on the electrodeposited MnOₓ samples in alkaline media consists of the following steps with the overall reaction shown in eq. 13:

MnO_{2,(s)}+H₂O+e⁻→MnOOH₍ₛ₎+OH⁻ (9)

2MnOOH₍ₛ₎+O₂→(MnOOH)_{2,(s)}*O_{2,(ads)} (10)

(MnOOH)_{2,(s)}*O_{2,(ads)}+e⁻→MnOOH₍ₛ₎*O_{(ads)}+OH⁻+MnO_{2,(s)} (rds) (11)

MnOOH₍ₛ₎*O_{(ads)}+e⁻→MnO_{2,(s)}+OH⁻ (12)

O₂+2H₂O+4e⁻→4OH⁻ (13)

In this Scenario, eq. 11 is the rate determining step (rds) and the co-existence of Mn³⁺ and Mn⁴⁺ enhances the oxygen reduction by assisting the charge transfer to molecular/adsorbed oxygen. Su et al., however, proposed other multistep 4-electron pathway for both ORR and OER on MnOₓ single crystals using Density Functional Theory (DFT) calculations. Their study focuses mainly on specific crystallographic forms of perfect MnOₓ single crystals such as Mn₃O₄ (001), α-Mn₂O₃ (110) and β-MnO₂ (110), neglecting the possibility of various defects such as intertwined structures, twinnings, numerous types of vacancies and kinetics of crystal structure transformations as well as changes in the Mn oxidation state during both ORR and OER. In spite of all of these assumptions and the fact that it is impossible to have such a pure structure in real world, the study gives some insights on the most active sites for ORR and OER among hand selection of manganese oxides, backed by experimental data. The mechanism is described as follow for ORR and OER, staring from eqs. 14 and 17, respectively:

O₂+H₂O+e⁻⇄HOO_{(ads)}+OH⁻ (14)

HOO_{(ads)}+e⁻⇄O_{(ads)}+OH⁻ (15)

O_{(ads)}+H₂O+e⁻⇄HO_{(ads)}+OH⁻ (16)

HO_{(ads)}+e⁻⇄OH⁻ (17)

where HOO_{(ads)}, HO_{(ads)} and O_{(ads)} intermediates bind to active sites through their oxygen atom. The constant difference between the binding energy levels of the HOO_{(ads)} and HO_{(ads)} intermediates for many metals and their oxides, also known as universal scaling relationship, contributes largely to the overpotential of both ORR and OER. Breaking away from this linear scaling relationship via modification of catalyst surfaces, enhances its activity for both ORR and OER, significantly lowers the reaction overpotentials. Su et al. reported that based on DFT calculations and assuming no kinetic difficulties, HO_{(ads)} covered α-Mn₂O₃ and O_{(ads)} covered β-MnO₂ sites are the most active surfaces for ORR and OER, respectively, among those studied. This further confirms the beneficial effects of Mn³⁺/Mn⁴⁺ co-existence toward enhanced ORR activity of the sample based on the Roche et al. mechanism discussed before (eq. 9-12).

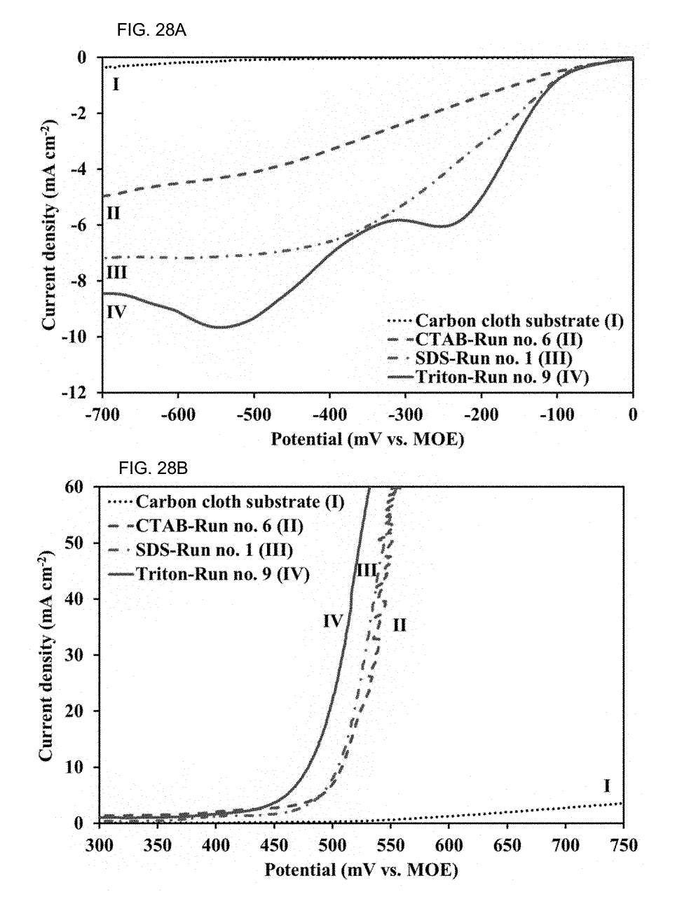

FIGS. 28A and 28B show a comparison between the ORR and OER performances of most active electrodeposited MnOₓ from each surfactant category. XPS studies have shown a mixture of Mn³⁺ and Mn⁴⁺ with higher contents of Mn³⁺ species including MnOOH for these samples (FIGS. 22, 24 and 26). However, it is not possible to determine the exact content of each Mn valances in different samples or identify the crystal structure of MnOₓ only with the help of XPS analysis. Further structural analysis is needed to find the crystallographic forms of these electrodeposited Mn oxides.

In the ORR region, the electrodeposited MnOₓ labeled as Triton run no. 9 shows highest ORR electrocatalytic activity with 1.4, 2.2 and 64 times higher ORR current densities at −550 mV_{MOE} comparing to the SDS run no. 1, CTAB run no. 6 and the carbon cloth substrate, respectively. The characteristic cathodic peaks observed for Triton run no. 9 at about −250 and −550 mV_{MOE} resemble the performance of β-MnO₂ (pyrolusite) in alkaline media with the first peak mainly due to the reduction of adsorbed oxygen on the unreduced active Mn⁴⁺ sites and the latter due to the reduction of dissolved oxygen on Mn³⁺/Mn⁴⁺ surfaces based on the mechanism discussed in eq. 9-12. Pyrolusite possesses a large oxygen sensitive specific area comparing to the other crystallographic forms of MnO₂, adsorbing high contents of O₂ and reducing it at more positive ORR potentials in alkaline media. The reduction peak corresponding to adsorbed oxygen is reported to disappear at high rotation speeds when the mass transport limitations for the reduction of bulk dissolved oxygen (second cathodic peak) are lifted, or in the case of crystal structures with low ability of oxygen adsorption such as electrodeposited MnOₓ at SDS no. 1 and CTAB no. 6. One can also refer the enhanced ORR activity of electrodeposited oxide in Triton run no. 9 to its nano-sized petal like microstructure of nano sheets with high porosity as shown in FIGS. 29A and 29B. This unique microstructure can also provide high surface area, further improving the ORR activity of the sample (FIGS. 28A, 29A and 29B). Both SDS run no. 1 and CTAB run no. 6 show similar Mn valances of 3+ and 4+ based on XPS analysis (FIGS. 24 and 26). Lowest ORR performance of the latter could be explained by the micron-sized petal shape microstructure together with needle like fibers with high length to thickness ratio (FIGS. 28A, 29C and 29D) while SDS run no. 1 show nano-sized sphere shape protrusions, i.e. between 200-400 nm in diameter (FIGS. 29E and 29F).

In the OER region, electrodeposited MnOₓ for Triton run no. 9 shows the lowest onset potential and highest OER current densities while the other two manganese oxides follow closely the Triton sample with SDS run no. 1 surpasses the OER activity of CTAB run no. 6 at 500 mV_{MOE} up to 550 mV_{MOE} where both show similar OER current densities (FIG. 28B). At 10 mA cm⁻², Triton run no. 9 provides the lowest OER onset potential of 479 mV_{MOE} at 10 mA cm⁻², about 25 mV lower than the SDS run no. 1 and CTAB run no. 6, over 400 mV_{MOE} lower than the carbon substrate (FIG. 28B). Su et al. showed both experimentally and theoretically via DFT modeling that the β-MnO₂ is the most active form of MnOₓ for OER in alkaline media. This, with the unique nano-sized porous petal shape microstructure could be the main reasons behind enhanced OER electrocatalytic activity of electrodeposited manganese oxide at Triton run no. 9 sample (FIGS. 28B, 29A and 29B). One can conclude that the surface modification of MnOₓ via surfactant-assisted electrodeposition can help destabilizing the HOO_{(ads)} and HO_{(ads)} intermediates, breaking away from the linear scaling relationship between their binding energies, enhancing the ORR and OER electrocatalytic activity of electrodeposited manganese oxides (eqs. 15 and 16). While Su et al. proposed that low number of adsorbed water molecules enhances the ORR activity based on the DFT calculations, Staszak-Jirkovský et al. argue that it could be more complicated than that since sensitive interaction between covalently bonded OH_{(ads)} and water molecules can form hydrogen-bonded complexes, i.e. HO_{(ads)} . . . H—OH, with specially configured water molecules called “activated water”, acting as a promoter for ORR. This can further enhance the ORR activity of the catalyst by facile transfer of protons to weakly adsorbed HOO_{(ads)}/O_{(ads)} intermediates and breaking away from the linear universal scaling relationship between binding energies of HOO_{ads}) and HO_{(ads)} (eqs. 14 and 16). The surface coverage of OH_{(ads)} has a defining role on the electrocatalytic activity of the catalyst since an optimum coverage is needed to provide sites for formation of HO_{(ads)} . . . H—OH complexes (promoter effect) as well as having bare catalyst sites necessary for formation of other reaction intermediates such as HOO_{(ads)} and O_{(ads)} (spectator effect).

Comparing the ORR and OER overpotentials (at −2 and 2 mA cm², respectively) for the electrodeposited manganese oxides investigated here with relevant catalyst materials from literature shows modest ORR activity but superior electrocatalytic activity towards OER (FIGS. 28A and 28B). The OER overpotentials (at 2 mA cm⁻²) of 234, 252 and 258 mV for Triton run no. 9, SDS run no. 1 and CTAB run no. 6, respectively, are at least 100 mV lower than 20% wt Ir/C, 20% wt Ru/C, Pt/IrO₂, Pt/Ir—IrO₂, Pt/Ir₃(IrO₂)₇ and Core-Corona Structured Bifunctional Catalyst (CCBC) (FIG. 28B). Triton run no. 9 provides the lowest OER overpotential (at 2 mA cm⁻²), i.e. 234 mV, among other investigated manganese oxides here which is close to the one for PDI activated MnO₂—Nd₃IrO₇, a highly active mixed oxide ORR/OER bifunctional catalyst after being activated by the K⁺ potential driven intercalation (PDI) method discussed in our previous work. Regarding the ORR, several noble metals and their oxides including nano-sized Ag, 20% wt Pt/C, Pt/Ir—IrO₂ and Pt/Ir₃(IrO₂)₇ generates up to 100 mV more positive overpotentials than −366, −406 and −482 mV for Triton run no. 9, SDS run no. 1 and CTAB run no. 6, respectively (FIG. 28A). However, the best ORR performing electrodeposited MnOₓ investigated here, i.e. Triton run no. 9, provides ORR overpotentials of 50 to 150 mV lower comparing to other non-precious metal catalysts such as Mn₂O₃, CoMn₂O₄, nanostructured Mn oxide thin film and Core-Corona Structured Bifunctional Catalyst (CCBC).

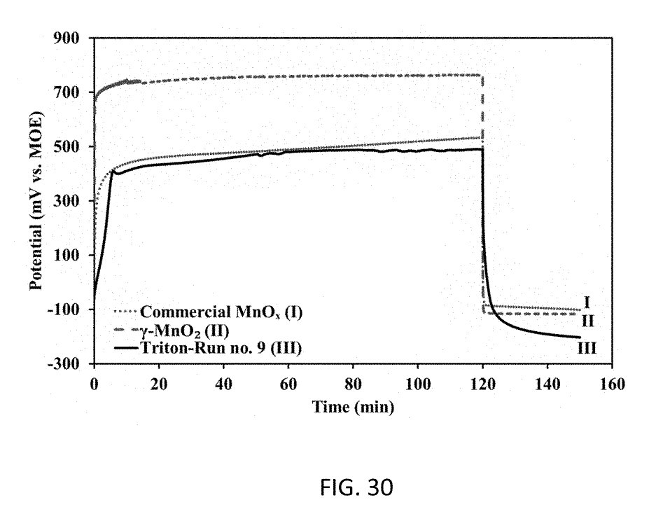

FIG. 30 presents the galvanostatic polarization comparison of the best performing electrodeposited MnOₓ, i.e. Triton run no. 9, and commercial manganese oxides. These galvanostatic polarization tests provide a preliminary insight into durability of catalysts since the applied current density and test duration were chosen to avoid limitations associated with the employed flooded electrode half-cell design such as limited dissolved oxygen needed during ORR and heavy oxygen gas evolution shielding the electrode surface during OER. In practice, air/oxygen breathing gas diffusion electrodes and electrolyte circulation would be employed as solutions to avoid dissolved oxygen limitations during ORR and O₂ gas evolution during OER, respectively.

In the OER region, electrodeposited MnOₓ sample in presence of Triton X-100 (β-MnO₂) shows lowest potentials with a steady performance after 60 min of testing at 5 mA cm⁻² (FIG. 30). The potential increases from 412 mV_{MOE} (at t=10 min) to 490 mV_{MOE} (at t=2 hrs) for Triton run no. 9 sample whereas in case of commercial MnOₓ GDE, it starts at 27 mV higher potentials, i.e. 439 mV_{MOE} (at t=10 min), and heads to 533 mV_{MOE} (at t=2 hrs) (FIG. 30). For γ-MnO₂ sample, high OER potential of 738 mV_{MOE} (at t=10 min) and 763 mV_{MOE} (at t=2 hrs) are recorded, showing poor OER electrocatalytic activity for this catalyst (FIG. 30). Superior OER activity of electrodeposited manganese oxides mainly comprised of β-MnO₂ is also confirmed by the DFT calculations of Su et al. which they refer to it as the most active form of MnOₓ for OER in alkaline media. Even though the rate of OER potential increase for the Triton run no. 9 sample is the second low, i.e. 43 mV h⁻¹, for the total 2 hrs of testing comparing to 51 and 14 mV h⁻¹ for commercial MnOₓ and γ-MnO₂, respectively, the electrodeposited manganese oxide shows low OER degradation rate as low as 5 mV h⁻¹ for the second half of OER performance testing unlike commercial MnOₓ (FIG. 30).

Regarding the galvanostatic ORR response (at −2 mA cm⁻²), the electrode potentials are −202, −100 and −116 mV_{MOE} for Triton run no. 9, commercial MnOₓ GDE and γ-MnO₂, respectively, depicting the commercial MnOₓ as the best ORR performing catalyst (FIG. 30). In terms of stability, however, γ-MnO₂ sample possesses lowest rate of ORR potential degradation of −2.4 mV h⁻¹ comparing to −173 and −29 mV h⁻¹ for Triton run no. 9 and commercial MnOₓ GDE, respectively.

Comparing the galvanostatic polarizations of the best performing electrodeposited MnOₓ, i.e. Triton run no. 9, with the fresh and PDI activated mixed oxides from our previous work, i.e. MnO₂—LaCoO₃ and MnO₂—Nd₃IrO₇, the electrodeposited manganese oxide shows promising OER activity (FIG. 30). The OER potential for the latter catalyst starts at 412 mV_{MOE} (t=10 min) at 5 mA cm⁻², about 100 mV lower than the PDI activated MnO₂—LaCoO₃ and finishes at 50 mV lower potential after 2 hrs of testing. In the ORR region, the electrodeposited catalyst generates similar potentials to PDI activated MnO₂—LaCoO₃ after 5 min of applying −2 mA cm⁻² and reaches −202 mV_{MOE}, similar to the fresh MnO₂—LaCoO₃ sample and 50 mV more negative than the PDI activated MnO₂—LaCoO₃.

Conclusion

A comprehensive study was performed via 2ⁿ half-fraction factorial design to investigate the effects of main factors, such as Mn²⁺ concentration, applied potential, temperature, surfactant type and concentration, as well as their two-factor interactions on the catalyst ORR and OER electrocatalytic activity during anodic electrodeposition of manganese oxides. Sodium dodecyl sulfate (SDS) as anioinc, hexadecyl-trimethyl-ammonium bromide (CTAB) as cataionic and Triton X-100 as non-ionic surfactants were employed in this study to electro-synthesize nanostructured MnOₓ while several surface characterization methods was used to analyze morphology and Mn valance of the synthesized catalysts. In the Triton X-100 cases, high surfactant concentration together with low applied anodic potential is believed to bring best ORR/OER bifunctional performances for the electrodeposited Mn oxides. Mn concentration was found to be an insignificant player. Temperature, on the other hand, is believed to have different effect depending on its value with high temperatures providing low ORR/OER potential window while low temperatures lead to high ORR/OER mass activities. In the SDS cases, the ORR/OER bifunctional responses of electrodeposited manganese oxides were sensitive to the Mn concentration with high Mn concentration leading to highest ORR mass activity and lowest ORR/OER potential window while low Mn concentration provides samples with highest OER mass activity. Overall, high surfactant concentration and low temperature was found to lead to preferable bifunctional activities. For CTAB samples, the highest ORR and OER mass activities were found to achieve at high surfactant concentration, low temperature and high Mn concentration. When it comes to the ORR/OER potential window, high temperature and low Mn concentration were more favorable. The effect of anodic applied potential on the ORR and OER activities of electrodeposited samples was found to be negligible in case of SDS and CTAB surfactants.

The surface modification of MnOₓ via surfactant-assisted electrodeposition can help destabilizing the HOO_{(ads)} and HO_{(ads)} intermediates, breaking away from the linear scaling relationship between their binding energies as a major contributor to the ORR and OER overpotentials, enhancing the ORR and OER electrocatalytic activity of electrodeposited manganese oxides. The formation of hydrogen-bonded complexes, i.e. HO_{(ads)} . . . H—OH, with specially configured water molecules called “activated water”, can further enhance the ORR activity of the catalyst by facile transfer of protons to weakly adsorbed HOO_{(ads)}/O_{(ads)} intermediates and breaking away from the linear universal scaling relationship. This, however, depends on the surface coverage of OH_{(ads)} providing sites for formation of HO_{(ads)} . . . H—OH complexes (promoter effect).

The electrodeposited MnOₓ for Triton run no. 9 was found to show the best ORR and OER electrocatalytic activities with the crystal structure of mainly β-MnO₂ and its nano-sized petal like microstructure of nano sheets with high porosity. Comparing to wide range of noble metals and their oxides such as Ir, Ru and IrO₂, the electrodeposited manganese oxide for Triton run no. 9 showed lower OER overpotential (min. 100 mV) at 2 mA cm⁻² while between 50 to 150 mV lower ORR overpotential at −2 mA cm⁻² was observed for the electrodeposited sample comparing to the other non-precious metals such as CoMn₂O₄ and Core-Corona Structured Bifunctional Catalyst (CCBC). The galvanostatic polarization tests further confirmed the promising OER activity of Triton run no. 9 with potentials as low as 490 mV_{MOE} (at t=2 hrs, i=5 mA cm⁻²), about 40 mV lower than commercial MnOₓ and degradation rate of 43 mV h⁻¹, about 10 mV h⁻¹ lower than its commercial counterpart.

In further summary, a systematic study has been performed to find an active nanostructured manganese oxide for both oxygen reduction and evolution reactions (ORR and OER, respectively) via a surfactant-assisted anodic electrodeposition method. The main and interaction effects of key electrodeposition factors that significantly influence the electrosynthesis of manganese oxides, i.e. Mn2+ concentration (C), applied anodic potential (E), temperature (T), surfactant type and concentration (S), on the bifunctional activity of MnOx have been studied using a two-level half-fraction factorial design. Sodium dodecyl sulfate (SDS) as anioinc, hexadecyl-trimethyl-ammonium bromide (CTAB) as cataionic and Triton X-100 as non-ionic surfactants were used in this study to electro-synthesize the nanostructured MnOx. Triton X-100 samples provide best performing nano-sized structures with promising ORR and OER performances comparing to both noble metals and other non-precious metals, i.e. between 50 to 150 mV lower ORR overpotential (at −2 mA cm⁻²) comparing to CoMn2O4 and Core-Corona Structured Bifunctional Catalyst (CCBC) and min. 100 mV lower OER overpotential (at 2 mA cm-2) comparing to Ir, Ru and IrO2. Galvanostatic polarizations at 5 mA cm-2 showed low OER potentials of 490 mV_{MOE} (at t=2 hrs), about 40 mV lower than commercial MnOx, and degradation rate of 43 mV h-1, about 10 mV h-1 lower than its commercial counterpart. The surface modifications of MnOx via surfactant-assisted electrodeposition can help destabilizing the HOO(ads) and HO(ads) intermediates, breaking away from the linear scaling relationship between their binding energies as a major contributor to the ORR and OER overpotentials, enhancing the ORR and OER electrocatalytic activity of electrodeposited manganese oxides. The formation of hydrogen-bonded complexes, i.e. HO(ads) . . . H—OH, with specially configured water molecules called “activated water”, can further enhance the ORR activity of the catalysts, depending on the surface coverage of OH(ads) which is needed to provide sites for formation of HO(ads) . . . H—OH complexes.

### Alternative Embodiment

In another embodiment of surfactant-assisted electrodeposition a 1×4 piece of Ni foam was cut and sonicated for 5 min in acetone following a through wash with DI water. A solution of 2 mM Co(CH₃COO)₂.4H₂O with 5% vol. Triton X-100 was made. Then, 0.1 M NaOH was added to it till the pH reached 7. The Ni foam was submerged in the final solution while applying anodic potential of 1051 mV_{MOE} at 343 K for different electrodeposition times of 1, 2 and 3 hrs. The sample was then dipped into an IPA solution at 343 K for 15 min to remove the surfactant from it, followed by a through DI water wash.

Next, the Ni foam with electrodeposited Co₂O₃ on it was submerged in 0.2 M La(NO₃)₃.6H₂O solution while applying a cathodic current density of −5.4 mA cm⁻² at 343 K for different periods of 1, 2 and 3 hrs so that the La⁺ could intercalate in the cobalt oxide structure, leading to an LaCoO₃ precursor. Following the La⁺ intercalation process, the sample was washed with DI water. Further heat treatments were employed to remove the water from LaCoO₃ precursor and later to make amorphous or crystalline LaCoO₃: The samples were heated at 673 and 873 K for 4 hrs followed by cooling in the furnace to synthesize amorphous and crystalline LaCoO₃, respectively.

### Conclusion

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

### REFERENCES

The following reference designations 1 to 92 relate to the description under the heading Enhancing the Bifunctional Activity and Durability of Oxygen Electrodes with Manganese Oxide Catalyst on pages 16 to 36 and are herein incorporated by reference:
1. K. F. Blurton and A. F. Sammells, Journal of Power Sources, 4, 263 (1979).
2. F. Cheng and J. Chen, Chem. Soc. Rev., 41, 2172 (2012).
3. R. Cao, J.-S. Lee, M. Liu and J. Cho, Advanced Energy Materials, 2, 816 (2012).
4. Z. Chen, A. Yu, D. Higgins, H. Li, H. Wang and Z. Chen, Nano Lett., 12, 1946 (2012).
5. Y. Li, M. Gong, Y. Liang, J. Feng, J.-E. Kim, H. Wang, G. Hong, B. Zhang and H. Dai, Nat Commun, 4, 1805 (2013).
6. J.-S. Lee, S. Tai Kim, R. Cao, N.-S. Choi, M. Liu, K. T. Lee and J. Cho, Advanced Energy Materials, 1, 34 (2011).
7. J. Ludwig, J. Power Sources, 155, 23 (2006).
8. B. B. Blizanac, P. N. Ross and N. M. Marković, The Journal of Physical Chemistry B, 110, 4735 (2006).
9. J. N. Tiwari, K. Nath, S. Kumar, R. N. Tiwari, K. C. Kemp, N. H. Le, D. H. Youn, J. S. Lee and K. S. Kim, Nat Commun, 4 (2013).
10. Y.-C. Lu, Z. Xu, H. A. Gasteiger, S. Chen, K. Hamad-Schifferli and Y. Shao-Horn, Journal of the American Chemical Society, 132, 12170 (2010).
11. B. C. Beard and P. N. Ross, Journal of The Electrochemical Society, 137, 3368 (1990).
12. P. H. Benhangi, A. Alfantazi and E. Gyenge, Electrochimica Acta, 123, 42 (2014).
13. J. O. M. Bockris and T. Otagawa, Journal of The Electrochemical Society, 131, 290 (1984).
14. J. O. M. Bockris, T. Otagawa and V. Young, J. Electroanal. Chem., 150, 633 (1983).
15. M. Bursell, M. Pirjamali and Y. Kiros, Electrochim. Acta, 47, 1651 (2002).
16. C. K. Lee, K. A. Striebel, F. R. McLarnon and E. J. Cairns, J. Electrochem. Soc., 144, 3801 (1997).
17. J. Suntivich, K. J. May, H. A. Gasteiger, J. B. Goodenough and Y. Shao-Horn, Science, 334, 1383 (2011).
18. S. Velraj and J. H. Zhu, Journal of Power Sources, 227, 48 (2013).
19. L. Wang, X. Zhao, Y. Lu, M. Xu, D. Zhang, R. S. Ruoff, K. J. Stevenson and J. B. Goodenough, Journal of The Electrochemical Society, 158, A1379 (2011).
20. N. H. Chou, P. N. Ross, A. T. Bell and T. D. Tilley, ChemSusChem, 4, 1566 (2011).
21. N. M. Marković and P. N. Ross, Journal of The Electrochemical Society, 141, 2590 (1994).
22. K. L. Pickrahn, S. W. Park, Y. Gorlin, H.-B.-R. Lee, T. F. Jaramillo and S. F. Bent, Adv. Energy Mater., 2, 1269 (2012).
23. W. H. Lee and H. Kim, Catalysis Communications, 12, 408 (2011).
24. Y. Gorlin and T. F. Jaramillo, Journal of the American Chemical Society, 132, 13612 (2010).
25. Y. Lee, J. Suntivich, K. J. May, E. E. Perry and Y. Shao-Horn, The Journal of Physical Chemistry Letters, 3, 399 (2012).
26. J. Sunarso, A. M. Glushenkov, A. A. J. Torriero, P. C. Howlett, Y. Chen, D. R. MacFarlane and M. Forsyth, Journal of The Electrochemical Society, 160, H74 (2013).
27. Y. Gorlin, C.-J. Chung, D. Nordlund, B. M. Clemens and T. F. Jaramillo, ACS Catalysis, 2, 2687 (2012).
28. Y. Chabre and J. Pannetier, Prog. Solid State Ch., 23, 1 (1995).
29. J. Desilvestro and O. Haas, Journal of The Electrochemical Society, 137, 5C (1990).
30. A. Aziznia, C. W. Oloman and E. L. Gyenge, J. Power Sources, 212, 154 (2012).
31. A. Aziznia, C. W. Oloman and E. L. Gyenge, ChemSusChem, 6, 847 (2013).
32. A. Serov, A. Aziznia, P. H. Benhangi, K. Artyushkova, P. Atanassov and E. Gyenge, Journal of Materials Chemistry A (2013).
33. A. Aziznia, C. W. Oloman and E. L. Gyenge, Journal of Power Sources, 265, 201 (2014).
34. S. L. Brock, N. Duan, Z. R. Tian, O. Giraldo, H. Zhou and S. L. Suib, Chemistry of Materials, 10, 2619 (1998).
35. E. L. Gyenge and J.-F. Drillet, J. Electrochem. Soc., 159, F23 (2012).
36. Y. Gorlin, B. Lassalle-Kaiser, J. D. Benck, S. Gul, S. M. Webb, V. K. Yachandra, J. Yano and T. F. Jaramillo, Journal of the American Chemical Society, 135, 8525 (2013).
37. F. Cheng, Y. Su, J. Liang, Z. Tao and J. Chen, Chemistry of Materials, 22, 898 (2009).
38. N. I. Andersen, A. Serov and P. Atanassov, Applied Catalysis B: Environmental, 163, 623 (2015).
39. Z. Chen, A. Yu, R. Ahmed, H. Wang, H. Li and Z. Chen, Electrochimica Acta, 69, 295 (2012).
40. J. Zhang, C. Guo, L. Zhang and C. M. Li, Chemical Communications, 49, 6334 (2013).
41. C. O. Soares, M. D. Carvalho, M. E. Melo Jorge, A. Gomes, R. A. Silva, C. M. Rangel and M. I. da Silva Pereira, J Appl Electrochem, 42, 325 (2012).
42. X. Li, W. Qu, J. Zhang and H. Wang, J. Electrochem. Soc., 158, A597 (2011).
43. S. P. Singh, R. N. Singh, G. Poillearat and P. Chartier, International Journal of Hydrogen Energy, 20, 203 (1995).
44. R. N. Singh, L. Bahadur, J. P. Pandey, S. P. Singh, P. Chartier and G. Poillerat, J Appl Electrochem, 24, 149 (1994).
45. M. Risch, A. Grimaud, K. J. May, K. A. Stoerzinger, T. J. Chen, A. N. Mansour and Y. Shao-Horn, The Journal of Physical Chemistry C, 117, 8628 (2013).
46. T. Takeguchi, T. Yamanaka, H. Takahashi, H. Watanabe, T. Kuroki, H. Nakanishi, Y. Orikasa, Y. Uchimoto, H. Takano, N. Ohguri, M. Matsuda, T. Murota, K. Uosaki and W. Ueda, Journal of the American Chemical Society, 135, 11125 (2013).
47. J. Suntivich, H. A. Gasteiger, N. Yabuuchi, H. Nakanishi, J. B. Goodenough and Y. Shao-Horn, Nat. Chem., 3, 546 (2011).
48. X. Yang, Y. Liu, S. Li, X. Wei, L. Wang and Y. Chen, Sci. Rep., 2 (2012).
49. M. V. ten Kortenaar, J. F. Vente, D. J. W. Ijdo, S. Müller and R. Kötz, Journal of Power Sources, 56, 51 (1995).
50. J. F. Vente and D. J. W. Ijdo, Materials Research Bulletin, 26, 1255 (1991).
51. H. Nishimine, Y. Doi, Y. Hinatsu and M. Sato, Journal of the Ceramic Society of Japan, 115, 577 (2007).
52. J. B. Goodenough, R. Manoharan and M. Paranthaman, Journal of the American Chemical Society, 112, 2076 (1990).
53. T. Poux, F. S. Napolskiy, T. Dintzer, G. Kéranguéven, S. Y. Istomin, G. A. Tsirlina, E. V. Antipov and E. R. Savinova, Catalysis Today, 189, 83 (2012).
54. C. C. L. McCrory, S. Jung, J. C. Peters and T. F. Jaramillo, Journal of the American Chemical Society, 135, 16977 (2013).
55. J. O. Bockris, apos and M., The Journal of Chemical Physics, 24, 817 (1956).
56. P. Castelli, S. Trasatti, F. H. Pollak and W. E. O'Grady, Journal of Electroanalytical Chemistry, 210, 189 (1986).
57. C. Bocca, A. Barbucci and G. Cerisola, International Journal of Hydrogen Energy, 23, 247 (1998).
58. J. O. Bockris and T. Otagawa, The Journal of Physical Chemistry, 87, 2960 (1983).
59. A. Kapalka, G. Fóti and C. Comninellis, Electrochemistry Communications, 10, 607 (2008).
60. H. Vogt, Ö. Aras and R. J. Balzer, International Journal of Heat and Mass Transfer, 47, 787 (2004).
61. I. C. Man, H.-Y. Su, F. Calle-Vallejo, H. A. Hansen, J. I. Martinez, N. G. Inoglu, J. Kitchin, T. F. Jaramillo, J. K. Nørskov and J. Rossmeisl, ChemCatChem, 3, 1159 (2011).
62. H.-Y. Su, Y. Gorlin, I. C. Man, F. Calle-Vallejo, J. K. Norskov, T. F. Jaramillo and J. Rossmeisl, Phys. Chem. Chem. Phys., 14, 14010 (2012).
63. E. J. Rubin and R. Baboian, Journal of The Electrochemical Society, 118, 428 (1971).
64. J. Suntivich, E. Perry, H. Gasteiger and Y. Shao-Horn, Electrocatalysis, 4, 49 (2013).
65. P. Ruetschi, Journal of The Electrochemical Society, 131, 2737 (1984).
66. P. Ruetschi and R. Giovanoli, Journal of The Electrochemical Society, 135, 2663 (1988).
67. R. Shannon, Acta Crystallographica Section A, 32, 751 (1976).
68. F. H. B. Lima, M. L. Calegaro and E. A. Ticianelli, J. Electroanal. Chem., 590, 152 (2006).
69. F. H. B. Lima, M. L. Calegaro and E. A. Ticianelli, Electrochimica Acta, 52, 3732 (2007).
70. M. Toupin, T. Brousse and D. Bélanger, Chemistry of Materials, 14, 3946 (2002).
71. M. Chigane and M. Ishikawa, Journal of The Electrochemical Society, 147, 2246 (2000).
72. N. Nagarajan, M. Cheong and I. Zhitomirsky, Materials Chemistry and Physics, 103, 47 (2007).
73. M. Minakshi, Journal of Electroanalytical Chemistry, 616, 99 (2008).
74. T. Riedl, T. Gemming and K. Wetzig, Ultramicroscopy, 106, 284 (2006).
75. L. Laffont and P. Gibot, Materials Characterization, 61, 1268 (2010).
76. H. K. Schmid and W. Mader, Micron (Oxford, England: 1993), 37, 426 (2006).
77. H. Kurata and C. Colliex, Physical Review B, 48, 2102 (1993).
78. G. H. Du, Z. Y. Yuan and G. Van Tendeloo, Applied Physics Letters, 86 (2005).
79. Y. Li, H. Tan, O. Lebedev, J. Verbeeck, E. Biermans, G. Van Tendeloo and B.-L. Su, Crystal Growth & Design, 10, 2969 (2010).
80. H. Tan, J. Verbeeck, A. Abakumov and G. Van Tendeloo, Ultramicroscopy, 116, 24 (2012).
81. J. Kaczmarek and E. Wolska, Journal of Solid State Chemistry, 103, 387 (1993).
82. J. McBreen, Electrochimica Acta, 20, 221 (1975).
83. M.-R. Gao, Y.-F. Xu, J. Jiang, Y.-R. Zheng and S.-H. Yu, Journal of the American Chemical Society, 134, 2930 (2012).
84. K.-W. Nam, M. G. Kim and K.-B. Kim, The Journal of Physical Chemistry C, 111, 749 (2006).
85. D. P. Dubal, A. D. Jagadale and C. D. Lokhande, Electrochimica Acta, 80, 160 (2012).
86. Y. Dai, K. Wang and J. Xie, Applied Physics Letters, 90 (2007).
87. D. P. Dubal, D. S. Dhawale, R. R. Salunkhe and C. D. Lokhande, Journal of Electroanalytical Chemistry, 647, 60 (2010).
88. B. Djurfors, J. N. Broughton, M. J. Brett and D. G. Ivey, Journal of Materials Science, 38, 4817 (2003).
89. F.-D. Kong, S. Zhang, G.-P. Yin, Z.-B. Wang, C.-Y. Du, G.-Y. Chen and N. Zhang, International Journal of Hydrogen Energy, 37, 59 (2012).
90. F.-D. Kong, S. Zhang, G.-P. Yin, N. Zhang, Z.-B. Wang and C.-Y. Du, Journal of Power Sources, 210, 321 (2012).
91. N. Sasikala, K. Ramya and K. S. Dhathathreyan, Energy Conversion and Management, 77, 545 (2014).
92. S.-Y. Huang, P. Ganesan, H.-Y. Jung and B. N. Popov, Journal of Power Sources, 198, 23 (2012).

The following reference designations 1 to 80 relate to the description under the heading Enhancing the Bifunctional Activity and Durability of Oxygen Electrodes with Manganese Oxide Catalyst on pages 36 to 58 and are herein incorporated by reference:
1. J.-S. Lee, S. Tai Kim, R. Cao, N.-S. Choi, M. Liu, K. T. Lee and J. Cho, Advanced Energy Materials, 1, 34 (2011).
2. A. Cross, A. Morel, A. Cormie, T. Hollenkamp and S. Donne, Journal of Power Sources, 196, 7847 (2011).
3. F. Cheng and J. Chen, Chem. Soc. Rev., 41, 2172 (2012).
4. V. Neburchilov, H. Wang, J. J. Martin and W. Qu, Journal of Power Sources, 195, 1271 (2010).
5. F. Cheng, Y. Su, J. Liang, Z. Tao and J. Chen, Chemistry of Materials, 22, 898 (2009).
6. F. W. T. Goh, Z. Liu, X. Ge, Y. Zong, G. Du and T. S. A. Hor, Electrochimica Acta, 114, 598 (2013).
7. J. Yang and J. J. Xu, Electrochemistry Communications, 5, 306 (2003).
8. P. H. Benhangi, A. Alfantazi and E. Gyenge, Electrochimica Acta, 123, 42 (2014).
9. K. L. Pickrahn, S. W. Park, Y. Gorlin, H.-B.-R. Lee, T. F. Jaramillo and S. F. Bent, Adv. Energy Mater., 2, 1269 (2012).
10. F. H. B. Lima, M. L. Calegaro and E. A. Ticianelli, J. Electroanal. Chem., 590, 152 (2006).
11. F. H. B. Lima, M. L. Calegaro and E. A. Ticianelli, Electrochimica Acta, 52, 3732 (2007).
12. H.-Y. Su, Y. Gorlin, I. C. Man, F. Calle-Vallejo, J. K. Norskov, T. F. Jaramillo and J. Rossmeisl, Phys. Chem. Chem. Phys., 14, 14010 (2012).
13. Y. Chabre and J. Pannetier, Prog. Solid State Ch., 23, 1 (1995).
14. S. L. Brock, N. Duan, Z. R. Tian, O. Giraldo, H. Zhou and S. L. Suib, Chemistry of Materials, 10, 2619 (1998).
15. E. L. Gyenge and J.-F. Drillet, J. Electrochem. Soc., 159, F23 (2012).
16. Y. Gorlin, B. Lassalle-Kaiser, J. D. Benck, S. Gul, S. M. Webb, V. K. Yachandra, J. Yano and T. F. Jaramillo, Journal of the American Chemical Society, 135, 8525 (2013).
17. A. Ramírez, P. Hillebrand, D. Stellmach, M. M. May, P. Bogdanoff and S. Fiechter, The Journal of Physical Chemistry C, 118, 14073 (2014).
18. J. W. D. Ng, M. Tang and T. F. Jaramillo, Energy & Environmental Science, 7, 2017 (2014).
19. X. Wang and Y. Li, Chemistry—A European Journal, 9, 300 (2003).
20. A. Perner, K. Holl, D. Ilic and M. Wohlfahrt-Mehrens, European Journal of Inorganic Chemistry, 2002, 1108 (2002).
21. R. Chitrakar, H. Kanoh, Y.-S. Kim, Y. Miyai and K. Ooi, Journal of Solid State Chemistry, 160, 69 (2001).
22. B. Ammundsen and J. Paulsen, Advanced Materials, 13, 943 (2001).
23. Y. Muraoka, H. Chiba, T. Atou, M. Kikuchi, K. Hiraga, Y. Syono, S. Sugiyama, S. Yamamoto and J.-C. Grenier, Journal of Solid State Chemistry, 144, 136 (1999).
24. S. Ching, D. J. Petrovay, M. L. Jorgensen and S. L. Suib, Inorganic Chemistry, 36, 883 (1997).
25. D. Tench and L. F. Warren, Journal of The Electrochemical Society, 130, 869 (1983).
26. S. Devaraj and N. Munichandraiah, The Journal of Physical Chemistry C, 112, 4406 (2008).
27. C. J. Clarke, G. J. Browning and S. W. Donne, Electrochimica Acta, 51, 5773 (2006).
28. G. M. Jacob and I. Zhitomirsky, Applied Surface Science, 254, 6671 (2008).
29. M. Nakayama, H. Tagashira, S. Konishi and K. Ogura, Inorganic Chemistry, 43, 8215 (2004).
30. B. A. Pinaud, Z. Chen, D. N. Abram and T. F. Jaramillo, The Journal of Physical Chemistry C, 115, 11830 (2011).
31. J. Tang, H.-M. Meng and L. L. Huang, RSC Advances, 4, 16512 (2014).
32. W. Wei, X. Cui, X. Mao, W. Chen and D. G. Ivey, Electrochimica Acta, 56, 1619 (2011).
33. C.-C. Hu, K.-H. Chang, Y.-T. Wu, C.-Y. Hung, C.-C. Lin and Y.-T. Tsai, Electrochemistry Communications, 10, 1792 (2008).
34. C.-W. Lee, K.-W. Nam, B.-W. Cho and K.-B. Kim, Microporous and Mesoporous Materials, 130, 208 (2010).
35. T. Shinomiya, V. Gupta and N. Miura, Electrochimica Acta, 51, 4412 (2006).
36. B. Babakhani and D. G. Ivey, Journal of Power Sources, 196, 10762 (2011).
37. S. Nijjer, J. Thonstad and G. M. Haarberg, Electrochimica Acta, 46, 395 (2000).
38. G. Qiu, H. Wen, Q. Guo, Y. Hu, D. Yang and F. Liu, Ionics, 17, 209 (2011).
39. J.-K. Chang and W.-T. Tsai, Journal of The Electrochemical Society, 150, A1333 (2003).
40. L. Chih-Hsiang and H. Chii-Shyang, Japanese Journal of Applied Physics, 47, 4682 (2008).
41. M. Ghaemi, L. Khosravi-Fard and J. Neshati, Journal of Power Sources, 141, 340 (2005).
42. A. Biswal, B. C. Tripathy, T. Subbaiah, D. Meyrick and M. Minakshi, Journal of The Electrochemical Society, 162, A30 (2015).
43. R. Vittal and H. Gomathi, The Journal of Physical Chemistry B, 106, 10135 (2002).
44. J. F. Rusling, Accounts of Chemical Research, 24, 75 (1991).
45. J. F. Rusling, Microporous Materials, 3, 1 (1994).
46. J. O. Besenhard, J. Gürtler, P. Komenda and A. Paxinos, Journal of Power Sources, 20, 253 (1987).
47. A. Biswal, B. Chandra Tripathy, K. Sanjay, T. Subbaiah and M. Minakshi, RSC Advances, 5, 58255 (2015).
48. A. Biswal, B. C. Tripathy, T. Subbaiah, D. Meyrick, M. Ionescu and M. Minakshi, Metallurgical and Materials Transactions E, 1, 226 (2014).
49. S. Devaraj and N. Munichandraiah, Journal of The Electrochemical Society, 154, A901 (2007).
50. Z. D. Wei, M. B. Ji, S. G. Chen, Y. Liu, C. X. Sun, G. Z. Yin, P. K. Shen and S. H. Chan, Electrochimica Acta, 52, 3323 (2007).
51. R. L. Paul and A. Cartwright, Journal of Electroanalytical Chemistry and Interfacial Electrochemistry, 201, 113 (1986).
52. R. L. Paul and A. Cartwright, Journal of Electroanalytical Chemistry and Interfacial Electrochemistry, 201, 123 (1986).
53. A. Cartwright and R. L. Paul, in Proceedings of the MnO2 Symposium, B. Schumm, H. M. Joseph and A. Kozawa Editors, p. 290, Tokyo (1980).
54. M. Fleischmann, H. R. Thirsk and I. M. Tordesillas, Transactions of the Faraday Society, 58, 1865 (1962).
55. M. Chigane and M. Ishikawa, Journal of The Electrochemical Society, 147, 2246 (2000).
56. M. Chigane, M. Ishikawa and M. Izaki, Journal of The Electrochemical Society, 148, D96 (2001).
57. N. Nagarajan, M. Cheong and I. Zhitomirsky, Materials Chemistry and Physics, 103, 47 (2007).
58. M. Toupin, T. Brousse and D. Bélanger, Chemistry of Materials, 14, 3946 (2002).
59. J. S. Foord, R. B. Jackman and G. C. Allen, Philosophical Magazine A, 49, 657 (1984).
60. F. Hahn, D. Floner, B. Beden and C. Lamy, Electrochimica Acta, 32, 1631 (1987).
61. M. Grdeń, M. Alsabet and G. Jerkiewicz, ACS Applied Materials & Interfaces, 4, 3012 (2012).
62. J. van Drunen, B. Kinkead, M. C. P. Wang, E. Sourty, B. D. Gates and G. Jerkiewicz, ACS Applied Materials & Interfaces, 5, 6712 (2013).
63. D. C. Montgomery, Design and Analysis of Experiments, Wiley, Hoboken, N.J. (2009).
64. L. Trotochaud and S. W. Boettcher, Scripta Materialia, 74, 25 (2014).
65. I. Roche, E. Chaînet, M. Chatenet and J. Vondrák, The Journal of Physical Chemistry C, 111, 1434 (2006).
66. I. C. Man, H.-Y. Su, F. Calle-Vallejo, H. A. Hansen, J. I. Martinez, N. G. Inoglu, J. Kitchin, T. F. Jaramillo, J. K. Nørskov and J. Rossmeisl, ChemCatChem, 3, 1159 (2011).
67. M. T. M. Koper, Journal of Electroanalytical Chemistry, 660, 254 (2011).
68. M. L. Calegaro, F. H. B. Lima and E. A. Ticianelli, Journal of Power Sources, 158, 735 (2006).
69. J. Staszak-Jirkovský, R. Subbaraman, D. Strmcnik, K. L. Harrison, C. E. Diesendruck, R. Assary, O. Frank, L. Kobr, G. K. H. Wiberg, B. Genorio, J. G. Connell, P. P. Lopes, V. R. Stamenkovic, L. Curtiss, J. S. Moore, K. R. Zavadil and N. M. Markovic, ACS Catalysis, 5, 6600 (2015).
70. Y. Gorlin and T. F. Jaramillo, Journal of the American Chemical Society, 132, 13612 (2010).
71. F.-D. Kong, S. Zhang, G.-P. Yin, Z.-B. Wang, C.-Y. Du, G.-Y. Chen and N. Zhang, International Journal of Hydrogen Energy, 37, 59 (2012).
72. F.-D. Kong, S. Zhang, G.-P. Yin, N. Zhang, Z.-B. Wang and C.-Y. Du, Journal of Power Sources, 210, 321 (2012).
73. Z. Chen, A. Yu, D. Higgins, H. Li, H. Wang and Z. Chen, Nano Lett., 12, 1946 (2012).
74. P. Hosseini-Benhangi, M. A. Garcia-Contreras, A. Alfantazi and E. L. Gyenge, Journal of The Electrochemical Society, 162, F1356 (2015).
75. N. Sasikala, K. Ramya and K. S. Dhathathreyan, Energy Conversion and Management, 77, 545 (2014).
76. J. Sunarso, A. M. Glushenkov, A. A. J. Torriero, P. C. Howlett, Y. Chen, D. R. MacFarlane and M. Forsyth, Journal of The Electrochemical Society, 160, H74 (2013).
77. J. O. Bockris, apos and M., The Journal of Chemical Physics, 24, 817 (1956).
78. P. Castelli, S. Trasatti, F. H. Pollak and W. E. O'Grady, Journal of Electroanalytical Chemistry, 210, 189 (1986).
79. C. Bocca, A. Barbucci and G. Cerisola, International Journal of Hydrogen Energy, 23, 247 (1998).
80. L.-A. Stern and X. Hu, Faraday Discussions, 176, 363 (2014).

1. A method of manufacturing an oxygen electrode, the method comprising:
(a) providing an electrically conductive substrate;
(b) depositing an electrocatalyst layer on the substrate; and
(c) intercalating alkali-metal ions into the electrocatalyst layer, wherein the intercalation is electric potential driven and the alkali-metal ions are provided by an alkali-metal salt dissolved in an aqueous solution.

2. The method of claim 1, wherein the electrocatalyst layer comprises at least one of the following: manganese oxide, a perovskite, and an oxide having a fluorite-related structure.

3. The method of claim 2, wherein the perovskite is lanthanum cobalt oxide with the formula LaCoOₓ, where x is between 0.1 to 5.

4. The method of claim 2 wherein the perovskite is lanthanum nickel oxide with the formula LaNiOₓ where x is between 0.1 to 5.

5. The method of claim 2, wherein the oxide having a fluorite-related structure is neodymium iridium oxide with the formula NdₓIrO_{y}, where x is between 0.1 to 5 and y is between 0.1 to 10.

6. The method of claim 1, wherein step (b) comprises depositing the electrocatalyst layer on the substrate using an anodic electrodeposition process in the presence of a surfactant.

7. The method of claim 6, wherein the surfactant is at least one of the following: sodium dodecyl sulfate, hexadecyl-trimethyl-ammonium bromide, and Triton X-100.

8. The method of claim 6, wherein the anodic electrodeposition process is performed at a temperature of between 295K and 343K.

9. The method of claim 6, wherein the anodic electrodeposition process is performed at an anodic potential of between 800 mV and 2000 mV vs. a mercury/mercury oxide (Hg/HgO) reference electrode (MOE).

10. The method of claim 6, wherein the anodic electrodeposition process is performed using a liquid bath having a surfactant concentration of between 0% vol and 30% by volume.

11. The method of claim 6, wherein the anodic electrodeposition process is performed using a liquid bath having a manganese (II) ion concentration of between 0.1M and 3M.

12. The method of claim 6, wherein the anodic electrodeposition process is performed using a liquid bath having a cobalt (II) or nickel (II) ion concentration of between 0.001M and 3M.

13. The method of claim 6, further comprising forming lanthanum (III) ions during the depositing of the electrocatalyst layer on the substrate using the anodic electrodeposition process, wherein the electrocatalyst layer comprises lanthanum cobalt oxide or lanthanum nickel oxide.

14. The method of claim 13 wherein the concentration of lanthanum (III) ions during the anodic electrodeposition process is between 0.001 M and 3M.

15. The method of claim 13, wherein the forming of lanthanum (III) ions is performed electrophoretically at a constant cathodic current density between −1 to −100 mA cm⁻².

16. The method of claim 1, wherein prior to depositing an electrocatalyst layer on the substrate, the substrate is pretreated using an acidic solution selected from a group consisting of: nitric acid, acetic acid, phosphoric acid, sulfuric acid and combinations thereof.

17. The method of claim 1, wherein the step of depositing an electrocatalyst layer on the substrate comprises spraying an electrocatalyst ink on the substrate.

18. The method of claim 17 wherein the electrocatalyst ink comprises at least one component selected from a group consisting of: manganese oxide particles, lanthanum cobalt oxide particles, lanthanum nickel oxide particles, neodymium iridium oxide particles, carbon particles, graphene flakes, nitrogen-doped graphene flakes, graphite fibers, graphite particles, multi walled carbon nanotubes, single walled carbon nanotubes, acetylene black, Nafion® resin solution or powder, polytetrafluoroethylene (PTFE) powder or suspension, water and isopropyl alcohol.

19. The method of claim 1, wherein prior to the intercalating alkali-metal ions into the catalyst layer, the substrate having the electrocatalyst layer deposited thereon is post-treated by washing in isopropyl alcohol.

20. The method of claim 19, wherein the potential driven intercalation of the alkali-metal ions is performed at a constant cathodic current density between −1 to −100 mA cm⁻².

21. The method of claim 20, wherein the alkali-metal is any one of the following: potassium, lithium, sodium, or cesium.

22. The method of claim 20, wherein the alkali-metal is a combination of any of the following: potassium, lithium, sodium and cesium.

23. The method of claim 1, wherein the electrically conductive substrate comprises any one of the following: carbon cloth, carbon fiber paper, graphite felt, metal mesh, metal foam, graphene, reticulated vitreous carbon, and carbon nanotubes.

24. The method of any one of claim 1, wherein the electrically conductive substrate is porous.

25. An oxygen electrode manufactured in accordance with the method of claim 1.

26. A metal-air battery comprising the oxygen electrode of claim 25.

27. A regenerative H₂—O₂ fuel cell comprising the oxygen electrode of claim 25.

28. A redox flow battery comprising the oxygen electrode of claim 25.

29. A direct fuel cell comprising the oxygen electrode of claim 25.

30. An electrochemical cell comprising the oxygen electrode of claim 25.
